(19) United States
(12) Patent Application Publication
(10) Pub. No.: US 2023/0022488 A1
(43) Pub. Date: Jan. 26, 2023

(54) Laundry Composition

(71) Applicant: FIRMENICH SA, Satigny (CH)

(72) Inventors: Arnaud STRUILLOU, Plainsboro, NJ (US); Lahoussine OUALI, Satigny (CH); Addi FADEL, Plainsboro, NJ (US); Kitty VAN GRUIJTHUIJSEN, Satigny (CH)

(21) Appl. No.: 17/757,694

(22) PCT Filed: Dec. 15, 2020
(86) PCT No.: PCT/EP2020/086273

§ 371 Date: Jun. 17, 2022

Related U.S. Application Data
(60) Provisional application No. 62/950,163, filed on Dec. 19, 2019.

(30) Foreign Application Priority Data
Feb. 4, 2020 (EP) 20155414.4

(51) Int. Cl. C11D 3/50; C11D 3/43

(52) U.S. Cl. CPC C11D 3/505; C11D 3/43

(57) ABSTRACT

Described herein is a laundry composition including a delivery system having a biodegradable carrier and a perfume formulation entrapped within the biodegradable carrier, a free perfume oil, and laundry additives.

### TECHNICAL FIELD

The present invention relates to a laundry composition comprising a delivery system comprising a biodegradable carrier and a perfume formulation entrapped within the biodegradable carrier, a free perfume oil and laundry additives.

### BACKGROUND OF THE INVENTION

Perfume additives make consumer products such as laundry compositions, more aesthetically pleasing to the consumer and in many cases the perfume imparts a pleasant fragrance to fabrics treated therewith. The amount of perfume carryover from an aqueous laundry bath onto fabrics, however, is often marginal. By using a delivery system, such as perfumes encapsulated in microcapsules, the delivery efficiency and active lifetime of the perfume additives can be improved. Delivery systems, such as microcapsules, provide several advantages, such as protecting the perfume from physical or chemical reactions with incompatible ingredients in the laundry composition, as well as protecting the perfume from volatilization or evaporation. Delivery systems, such as microcapsules, can be particularly effective in the delivery and preservation of perfumes in that the perfumes can be delivered to and retained within the fabric by a microcapsule that only ruptures, and therefore releases the perfume, when the fabric is dry.

Scent associated with laundered laundry is important to many consumers. There are many so called “touch points” that consumers associated with during the laundry experience. Non-limiting examples of these touch points include the freshness experience associated with opening a fabric care container, opening a washing machine after washing laundry, opening a laundry dryer after drying laundry, and freshness associated with wearing laundered clothes. It has been reported that there is a significant portion of consumers that will fold and put away their laundry about one day after having laundered laundry. Freshness while folding laundry about one day after having laundered laundry also signals to the consumer that the laundry is clean.

Laundry compositions comprising delivery systems, such as microcapsules, providing a prolonged delivery of an olfactive effect are known from the prior art, but there is still a need in the industry for improving the ecological footprint of laundry compositions, in particular with regard to the sustainability and, preferably, with regard to the stability for a delivery system to thereby improve the biodegradability and preferably reduce the leakage of a perfume from the delivery system and preferably provide an improved impact of the perfume upon release to the consumer.

The present invention satisfies these and other needs of the industry.

### DETAILED DESCRIPTION OF THE INVENTION

The present invention relates to a laundry composition comprising
a delivery system comprising a biodegradable carrier and a perfume formulation entrapped within the biodegradable carrier,
a free perfume oil, and
laundry additives.

By laundry composition it is herein understood a composition which is expected to deliver among different benefits a perfuming effect to fabrics, laundry, textile etc. and at the same time provides an additional effect, such as cleaning, softening etc, to the fabrics, laundry, textile etc. to which it is applied. In other words, a laundry composition according to the invention is a manufactured product which comprises a functional formulation also referred to as “base”, together with benefit agents, among which an effective amount of the delivery system defined herein above and which provides a perfuming effect to the fabrics, laundry, textile etc. and at the same time provides an additional effect, such as cleaning, softening etc., to the fabrics, laundry, textile etc to which it is applied.

By delivery system it is herein understood to protect active ingredients, in particular of a perfume formulation and the perfume comprised within the perfume formulation, and/or to control their release.

By carrier or carrier material is herein understood that the material of the carrier is suitable to entrap, encapsulate or hold a certain amount of perfume formulation. In order to be qualified as a carrier material, the carrier material has to entrap, encapsulate or hold a certain amount of perfume.

Typically, when the delivery system is in a matrix form, the carrier material is a matrix material and the delivery system has to entrap preferably at least 20 wt. %, preferably at least 30 wt. %, even more preferably at least 35 wt. % of the perfume formulation, based on the total weight of the delivery system.

Typically, when the delivery system is in the form a core-shell microcapsule, the carrier is a shell and the delivery system has to entrap preferably at least 80 wt. %, preferably at least 90 wt. %, of the perfume formulation, based on the total weight of the delivery system.

In a particular embodiment, the carrier or carrier material is a solid carrier material, i.e. an emulsion or solvent is not a carrier or carrier material.

In a particular embodiment, the delivery system is a core-shell microcapsule or the delivery system is in a matrix form (i.e oil entrapped within a polymeric matrix, for example a monomeric, oligomeric or polymeric carrier matrix), preferably wherein the delivery system is a core-shell microcapsule having a biodegradable shell. For the sake of clarity, thereby it is understood that when the delivery system is a core-shell microcapsule, the perfume formulation is comprised in the core which is surrounded or entrapped by the biodegradable shell. When the delivery system is in the form of a matrix, the perfume formulation is entrapped in a biodegradable matrix of a carrier, such as a monomeric, oligomeric or polymeric carrier matrix, by adsorption in the matrix.

In case the carrier is a biodegradable monomeric, oligomeric or polymeric carrier matrix, it is herein understood that the perfume formulation is entrapped in the biodegradable monomeric, oligomeric or polymeric carrier matrix by adsorption within the biodegradable monomeric, oligomeric or polymeric carrier matrix, i.e. it is adsorbed in the pores of the biodegradable monomeric, oligomeric or polymeric carrier matrix.

In a particular embodiment, the biodegradable carrier material comprises a biodegradable monomeric, oligomeric or polymeric carrier material, or mixtures of two or more of these. An oligomeric carrier is a carrier wherein 2-10 monomeric units are linked by covalent bonds. For example, if the oligomeric carrier is a carbohydrate, the oligomeric carrier may be sucrose, lactose, raffinose, maltose, trehalose, fructo-oligosaccharides.

Examples of a monomeric carrier materials are glucose, fructose, mannose, galactose, arabinose, fucose, sorbitol, mannitol, for example.

Polymeric carriers have more than 10 monomeric units that are linked by covalent bonds.

In a particular embodiment, the carrier may be a biodegradable polymeric carrier material. Non-limiting examples of polymeric carrier material includes polyaspartate, modified polysuccinimides, lignin and its derivatives, polyoxazoline, polyhydroxyalcanoates, polyphenols, natural and synthetic clays polyvinyl acetates, polyvinyl alcohol, dextrines, maltodextrines, glucose syrups, natural or modified starch, polysaccharides, carbohydrates, chitosan, gum Arabic, polyethylene glycol, polyvinyl pyrrolidone, polyvinyl alcohol, acrylamides, acrylates, polyacrylic acid and related, maleic anhydride copolymers, amine-functional polymers, vinyl ethers, styrenes, polystyrenesulfonates, vinyl acids, ethylene glycol-propylene glycol block copolymers, vegetable gums, gum acacia, pectins, xanthanes, alginates, carragenans or cellulose derivatives, such as carboxymethyl methylcellulose, methylcellulose or hydroxyethyl cellulose; chitin, proteins (animal and vegetal), polyaspartate, poylsuccinimides and its derivatives, polyesters, polyaminoesters, polyhydroxyalkanoates, polycarbonates and mixture thereof. Preferably the polymeric carrier material comprises natural or modified starch, maltodextrins, carbohydrates, chitin, proteins (animal and vegetal), polyaspartate, poylsuccinimides and its derivatives, polyesters, polyaminoesters, polyhydroxyalkanoates, polycarbonates and mixtures thereof.

The biodegradable carrier material is preferably present in an amount between 25 and 80 wt. %, preferably between 30 and 60 wt. % and more preferably between 40 and 55 wt. % (based on the total weight of the delivery system).

In a preferred embodiment, the polymeric carrier material may further comprise a fireproofing agent, preferably selected from the group consisting of sodium silicate, potassium silicate, sodium carbonate, sodium hydrogencarbonate, monoammonium phosphate or carbonate, diammonium phosphate, mono-, di- or trisodium phosphate, sodium hypophosphite, melamine cyanurate, chlorinated hydrocarbons, talc and mixtures thereof.

In case the delivery system is a core-shell microcapsule having a biodegradable shell, it is herein understood that the perfume formulation is comprised in the core which is surrounded by a biodegradable shell wall of the microcapsule.

The nature of the biodegradable shell of the microcapsules of the invention can vary.

As non-limiting examples, the biodegradable shell can comprises a material selected from the group consisting of polyurea, polyurethane, polyamide, polyhydroxyalkanoates, polyacrylate, polyesters, polyaminoesters, polyepoxides, polysiloxane, polycarbonate, polysulfonamide, urea formaldehyde, melamine formaldehyde resin, melamine formaldehyde resin cross-linked with polyisocyanate or aromatic polyols, melamine urea resin, melamine glyoxal resin, gelatin/gum arabic shell wall, and mixtures thereof.

In a first particular embodiment of the core-shell microcapsules, the core-shell microcapsule comprises a coacervate shell.

In a particular embodiment, the coacervate comprises a first polyelectrolyte and a second polyelectrolyte.

A first polyelectrolyte (Polyelectrolyte I) of one charge, preferably selected among proteins (such as gelatin), polypeptides or polysaccharides (such as chitosan) that are able to interact with an electrolyte or polyelectrolyte that has an opposite charge to thus form a coacervate phase having the ability to coat hydrophobic interfaces in order to form the capsules. In a preferred embodiment, Polyelectrolyte I is positively charged for pH<8 and optionally forms gels or highly viscous solutions in water below the gelling temperature, and lower viscosity solutions in water at a temperature above the melting point of the gel. The viscosity above the gelling temperature is typically lower than 0.1 Pa·s; below the gelling temperature, the elastic modulus G′ of the gel is typically in the range 0.1-15 kPa when measured during the first 24 hours after gel formation, using the measurement methods based on shear rheometry (such methods, along with the definitions relevant for the gelling temperature, are described, for example, in Parker, A. and Normand, V., Soft Matter, 6, pp 4916-4919 (2010). Preferably, Polyelectrolyte I is a gelatin material.

A second polyelectrolyte (Polyelectrolyte II), which is preferably selected among polysaccharides or another polymer bearing charges of opposite sign compared to Polyelectrolyte I. Generally, Polyelectrolyte II is negatively charged for pH>2. Preferably; such polyelectrolytes are, for example, alginate salts, cellulose derivatives guar gum, pectinate salts, carrageenan, polyacrylic and methacrylic acid or xanthan gum, or yet plant gums such as acacia gum. Most preferably, it is acacia gum (gum arabic).

The ratio between polyelectrolyte 1 and polyelectrolyte 2 is preferably comprised between 10/0.1 to 0.1/10, preferably between 10/1 and 1/10 and more preferably between 6/1 and 1/6.

According to a particular embodiment, the first polyelectrolyte carries a net positive charge when the pH is less than 8 while the second polyelectrolyte carries a net negative charge when the pH is greater than 2.

According to a particular embodiment, the first polyelectrolyte is gelatin and the second polyelectrolyte is selected from the group consisting of gum arabic, xanthan, alginate salts, cellulose derivatives, for example carboxymethyl cellulose, sodium carboxymethyl guar gum, pectinate salts, carrageenan, polyacrylic and methacrylic acid, xanthan gum and plant gums and/or mixtures thereof.

According to a preferred embodiment, the first polyelectrolyte is gelatin and the second is gum Arabic.

According to an embodiment, the coacervate material is present as a gel. According to a particular embodiment, the coacervate first material is a gel formed by providing conditions sufficient to induce gelation of either the first, the second, or both polyelectrolytes. Gelation may be induced by lowering the temperature below the gelling temperature of one of the polyelectrolytes, as detailed above and in the references cited in the previous section. For ionically cross-linkable polyelectrolytes such as chitosan, gelation may be induced by adding appropriate counter-ions such as tri-polyphosphate.

According to a preferred embodiment, the coacervate first material is hardened chemically using a suitable cross-linker such as glutaraldehyde, glyoxal, formaldehyde, tannic acid or genipin. According to another preferred embodiment, the coacervate first material is hardened enzymatically using an enzyme such as transglutaminase

According to another embodiment, the coacervate is not cross-linked.

In a particular embodiment of the core-shell microcapsules, the core-shell microcapsule comprises an oil-based core comprising the perfume formulation and a composite shell comprising a first material and a second material, wherein the first material and the second material are different, the first material is a coacervate, the second material is a polymeric material. According to an embodiment, the second polymeric material is selected from the group consisting of polyurea, polyurethane, polyamide, polyester, polyacrylate, polysiloxane, polycarbonate, polysulfonamide, polymers of urea and formaldehyde, melamine and formaldehyde, melamine and urea, or melamine and glyoxal and mixtures thereof.

According to a particular embodiment, the second material is polyurea and/or polyurethane.

According to an embodiment, the second material is present in an amount less than 3%, preferably less than 1% by weight based on the total weight of the microcapsule slurry. Indeed, it has been underlined that even with a reduced amount of the second material forming the wall, microcapsules still show good stability in consumer products.

In an another particular embodiment, a core-shell as defined above, based on an inner shell of a polymeric material and an outer shell of a coacervate is excluded from the present invention.

In a second particular embodiment of the core-shell microcapsules, the core-shell microcapsule comprises
an oil-based core comprising the perfume formulation
optionally an inner shell made of a polymerized polyfunctional monomer;
a biopolymer shell comprising a protein, wherein at least one protein is cross-linked.

According to an embodiment, the protein is chosen in the group consisting of milk proteins, caseinate salts such as sodium caseinate or calcium caseinate, casein, whey protein, hydrolyzed proteins, gelatins, gluten, pea protein, soy protein, silk protein and mixtures thereof.

According to an embodiment, the protein comprises sodium caseinate, preferably cross-linked sodium caseinate.

According to an embodiment, the protein comprises sodium caseinate and a globular protein, preferably chosen in the group consisting of whey protein, beta-lactoglobulin, ovalbumine, bovine serum albumin, vegetable proteins, and mixtures thereof.

The protein is preferably a mixture of sodium caseinate and whey protein.

According to an embodiment, the biopolymer shell comprises a crosslinked protein chosen in the group consisting of sodium caseinate and/or whey protein.

According to a particular embodiment, the microcapsules slurry comprises at least one microcapsule made of:
an oil-based core comprising the perfume formulation
an inner shell made of a polymerized polyfunctional monomer; preferably a polyisocyanate having at least two isocyanate functional groups
a biopolymer shell comprising a protein, wherein at least one protein is cross-linked; wherein the protein contains preferably a mixture comprising sodium caseinate and a globular protein, preferably whey protein.
optionally at least an outer mineral layer.

According to an embodiment, sodium caseinate and/or whey protein is (are) cross-linked protein(s).

The weight ratio between sodium caseinate and whey protein is preferably comprised between 0.01 and 100, preferably between 0.1 and 10, more preferably between 0.2 and 5.

In another particular embodiment, a core-shell as defined above, based on an inner shell of a polymeric material and a biopolymer shell comprising a protein is excluded from the present invention.

In another particular embodiment of the core-shell microcapsules, the core-shell microcapsule is a polyamide core-shell polyamide microcapsule comprising:
an oil based core comprising the perfume formulation, and
a polyamide shell comprising:
   an acyl chloride,
   a first amino compound, and
   a second amino compound.

According to a particular embodiment, the polyamide core-shell microcapsule comprises:
an oil based core comprising the perfume formulation, and
a polyamide shell comprising:
   an acyl chloride, preferably in an amount comprised between 5 and 98%, preferably between 20 and 98%, more preferably between 30 and 85% w/w
   a first amino compound, preferably in an amount comprised between 1% and 50% w/w, preferably between 7 and 40% w/w;
   a second amino compound, preferably in an amount comprised between 1% and 50% w/w, preferably between 2 and 25% w/w
   a stabilizer, preferably a biopolymer, preferably in an amount comprised between 0 and 90%, preferably between 0.1 and 75%, more preferably between 1 and 70%.

According to a particular embodiment, the polyamide core-shell microcapsule comprises:
an oil based core comprising the perfume formulation, and
a polyamide shell comprising:
   an acyl chloride,
   a first amino-compound being an amino-acid, preferably chosen in the group consisting of L-Lysine, L-Arginine, L-Histidine, L-Tryptophane and/or mixture thereof.
   a second amino.compound chosen in the group consisting of ethylene diamine, diethylene triamine, cystamine and/or mixture thereof, and
   a biopolymer chosen in the group consisting of casein, sodium caseinate, bovin serum albumin, whey protein, and/or mixture thereof.

The first amino-compound is different from the second amino-compound.

In another particular embodiment, a polyamide core-shell as defined above, is excluded from the present invention.

According to a particular embodiment of the invention, microcapsules according to the invention comprise an outer coating material selected from the group consisting of a polysaccharide, a cationic polymer and mixtures thereof to form an outer coating to the microcapsule.

Polysaccharide polymers are well known to a person skilled in the art. Preferred nonionic polysaccharides are selected from the group consisting of locust bean gum, xyloglucan, guar gum, hydroxypropyl guar, hydroxypropyl cellulose and hydroxypropyl methyl cellulose, pectin and mixtures thereof.

According to a particular embodiment, the coating consists of a cationic coating.

Cationic polymers are also well known to a person skilled in the art. Preferred cationic polymers have cationic charge densities of at least 0.5 meq/g, more preferably at least about 1.5 meq/g, but also preferably less than about 7 meq/g, more preferably less than about 6.2 meq/g. The cationic charge density of the cationic polymers may be determined by the Kjeldahl method as described in the US Pharmacopoeia under chemical tests for Nitrogen determination. The preferred cationic polymers are chosen from those that contain units comprising primary, secondary, tertiary and/or quaternary amine groups that can either form part of the main polymer chain or can be borne by a side substituent directly connected thereto. The weight average (Mw) molecular weight of the cationic polymer is preferably between 10,000 and 3.5M Dalton, more preferably between 50,000 and 2M Dalton.

According to a particular embodiment, one will use cationic polymers based on acrylamide, methacrylamide, N-vinylpyrrolidone, quaternized N,N-dimethylaminomethacrylate, diallyldimethylammonium chloride, quaternized vinylimidazole (3-methyl-1-vinyl-1H-imidazol-3-ium chloride), vinylpyrrolidone, acrylamidopropyltrimonium chloride, cassia hydroxypropyltrimonium chloride, guar hydroxypropyltrimonium chloride or polygalactomannan 2-hydroxypropyltrimethylammonium chloride ether, starch hydroxypropyltrimonium chloride and cellulose hydroxypropyltrimonium chloride. Preferably copolymers shall be selected from the group consisting of polyquaternium-5, polyquaternium-6, polyquaternium-7, polyquaternium10, polyquaternium-11, polyquaternium-16, polyquaternium-22, polyquaternium-28, polyquaternium-43, polyquaternium-44, polyquaternium-46, cassia hydroxypropyltrimonium chloride, guar hydroxypropyltrimonium chloride or polygalactomannan 2-hydroxypropyltrimethylammonium chloride ether, starch hydroxypropyltrimonium chloride and cellulose hydroxypropyltrimonium chloride

As specific examples of commercially available products, one may cite Salcare® SC60 (cationic copolymer of acrylamidopropyltrimonium chloride and acrylamide, origin: BASF) or Luviquat®, such as the PQ 11N, FC 550 or Style (polyquaternium-11 to 68 or quaternized copolymers of vinylpyrrolidone origin: BASF), or also the Jaguar® (C13S or 017, origin Rhodia).

According to any one of the above embodiments of the invention, there is added an amount of polymer described above comprised between about 0% and 5% w/w, or even between about 0.1% and 2% w/w, percentage being expressed on a w/w basis relative to the total weight of the microcapsule. It is clearly understood by a person skilled in the art that only part of said added polymers will be incorporated into/deposited on the microcapsule shell.

In a particular embodiment, the biodegradable carrier, preferably being either a biodegradable core-shell microcapsule or a biodegradable monomeric, oligomeric or polymeric matrix material, has a biodegradability of at least 65%, 70%, 75%, 80%, 85%, 90%, 95% or 98% within 60 days according to OECD301F.

OECD301F is a standard test method on the biodegradability from the Organisation of Economic Co-operation and Development.

In a particular embodiment, the perfume formulation comprises
0 to 60 wt. % of a hydrophobic solvent (based on the total weight of the perfume formulation),
40 to 100 wt. % of a perfume oil (based on the total weight of the perfume formulation),
optionally, other active ingredients.

By “perfuming formulation” it is herein understood a formulation which is for fine and functional perfumery. In particular, perfuming ingredients, solvents or adjuvants of current use can be combined for the preparation of a perfume formulation.

The perfuming ingredients may be dissolved in a solvent of current use in the perfume industry. The solvent is preferably not an alcohol. Examples of such solvents are diethyl phthalate, isopropyl myristate, Abalyn® (rosin resins, available from Eastman), benzyl benzoate, ethyl citrate, limonene or other terpenes, triacetin or isoparaffins, preferably Abalyn®, benzyl benzoate, limonene or other terpenes, or isoparaffins.

Preferably, the solvent is very hydrophobic and highly sterically hindered, like for example Abalyn® or benzyl benzoate. Preferably the perfume comprises less than 30% of solvent. More preferably the perfume comprises less than 20% and even more preferably less than 10% of solvent, all these percentages being defined by weight relative to the total weight of the perfume. Most preferably, the perfume is essentially free of solvent.

According to a particular embodiment, the hydrophobic solvent is a density balancing material preferably chosen in the group consisting of benzyl salicylate, benzyl benzoate, cyclohexyl salicylate, benzyl phenylacetate, phenylethyl phenylacetate, triacetin, ethyl citrate, methyl and ethyl salicylate, benzyl cinnamate, and mixtures thereof.

A “density balancing material” should be understood as a material having a density preferably greater than 1.07 g/cm³ and having preferably low or no odor.

The density of a component is defined as the ratio between its mass and its volume (g/cm³).

Several methods are available to determine the density of a component.

One may refer for example to the ISO 298:1998 method to measure d20 densities of essential oils.

By “perfume oil” (or also “perfume”) or “flavour” is herein understood an ingredient or composition that is a liquid at about 20° C. Said perfume or flavour oil can be a perfuming or flavouring ingredient alone or a mixture of ingredients in the form of a perfuming or flavouring composition. As a “perfuming ingredient” it is meant here a compound, which is used in perfuming preparations or compositions to impart as primary purpose a hedonic effect. In other words such an ingredient, to be considered as being a perfuming one, must be recognized by a person skilled in the art as being able to at least impart or modify in a positive or pleasant way the odor of a composition, and not just as having an odor. The nature and type of the perfuming ingredients present in the oil phase do not warrant a more detailed description here, which in any case would not be exhaustive, the skilled person being able to select them on the basis of its general knowledge and according to intended use or application and the desired organoleptic effect. In general terms, these perfuming ingredients belong to chemical classes as varied as alcohols, aldehydes, ketones, esters, ethers, acetates, nitriles, terpenoids, nitrogenous or sulphurous heterocyclic compounds and essential oils, and said perfuming co-ingredients can be of natural or synthetic origin. Many of these co-ingredients are listed in reference texts such as the book by S. Arctander, Perfume and Flavor Chemicals, 1969, Montclair, N.J., USA, or its more recent versions, or in other works of a similar nature, as well as in the abundant patent literature in the field of perfumery. It is also understood that said ingredients may also be compounds known to release in a controlled manner various types of perfuming compounds.

In particular one may cite perfuming ingredients which are commonly used in perfume formulations, such as:
Aldehydic ingredients: decanal, dodecanal, 2-methyl-undecanal, 10-undecenal, octanal, nonanal and/or nonenal;
Aromatic-herbal ingredients: eucalyptus oil, camphor, eucalyptol, 5-methyltricyclo[6.2.1.0˜2,7˜]undecan-4-one, 1-methoxy-3-hexanethiol, 2-ethyl-4,4-dimethyl-1,3-oxathiane, 2,2,7/8,9/10-Tetramethylspiro[5.5]undec-8-en-1-one and/or menthol;
Balsamic ingredients: coumarin, ethylvanillin and/or vanillin;
Citrus ingredients: dihydromyrcenol, citral, orange oil, linalyl acetate, citronellyl nitrile, orange terpenes, 1-p-menthen-8-yl acetate and/or 1,4(8)-p-menthadiene;
Floral ingredients: methyl dihydrojasmonate, linalool, citronellol, phenylethanol, 3-(4-tert-butylphenyl)-2-methylpropanal, hexylcinnamic aldehyde, benzyl acetate, tetrahydro-2-isobutyl-4-methyl-4(2H)-pyranol, beta ionone, methyl 2-(methylamino)benzoate, (E)-3-methyl-4-(2,6,6-trimethyl-2-cyclohexen-1-yl)-3-buten-2-one, (1E)-1-(2,6,6-trimethyl-2-cyclohexen-1-yl)-1-penten-3-one, 1-(2,6,6-trimethyl-1,3-cyclohexadien-1-yl)-2-buten-1-one, (2E)-1-(2,6,6-trimethyl-2-cyclohexen-1-yl)-2-buten-1-one, (2E)-1-[2,6,6-trimethyl-3-cyclohexen-1-yl]-2-buten-1-one, (2E)-1-(2,6,6-trimethyl-1-cyclohexen-1-yl)-2-buten-1-one, 2,5-dimethyl-2-indanmethanol, 2,6,6-trimethyl-3-cyclohexene-1-carboxylate, 3-(4,4-dimethyl-1-cyclohexen-1-yl)propanal, hexyl salicylate, 3,7-dimethyl-1,6-nonadien-3-ol, 3-(4-isopropylphenyl)-2-methylpropanal, verdyl acetate, geraniol, p-menth-1-en-8-ol, 4-(1,1-dimethylethyl)-1-cyclohexyle acetate, 1,1-dimethyl-2-phenylethyl acetate, 4-cyclohexyl-2-methyl-2-butanol, amyl salicylate, high cis methyl dihydrojasmonate, 3-methyl-5-phenyl-1-pentanol, verdyl proprionate, geranyl acetate, tetrahydro linalool, cis-7-p-menthanol, propyl (S)-2-(1,1-dimethylpropoxy)propanoate, 2-methoxynaphthalene, 2,2,2-trichloro-1-phenylethyl acetate, 4/3-(4-hydroxy-4-methylpentyl)-3-cyclohexene-1-carbaldehyde, amylcinnamic aldehyde, 8-decen-5-olide, 4-phenyl-2-butanone, isononyle acetate, 4-(1,1-dimethylethyl)-1-cyclohexyl acetate, verdyl isobutyrate and/or mixture of methylionones isomers;
Fruity ingredients: gamma-undecalactone, 2,2,5-trimethyl-5-pentylcyclopentanone, 2-methyl-4-propyl-1,3-oxathiane, 4-decanolide, ethyl 2-methyl-pentanoate, hexyl acetate, ethyl 2-methylbutanoate, gamma-nonalactone, allyl heptanoate, 2-phenoxyethyl isobutyrate, ethyl 2-methyl-1,3-dioxolane-2-acetate, 3-(3,3/1,1-dimethyl-5-indanyl)propanal, diethyl 1,4-cyclohexanedicarboxylate, 3-methyl-2-hexen-1-yl acetate, 1-[3,3-dimethylcyclohexyl]ethyl [3-ethyl-2-oxiranyl]acetate and/or diethyl 1,4-cyclohexane dicarboxylate;
Green ingredients: 2-methyl-3-hexanone (E)-oxime, 2,4-dimethyl-3-cyclohexene-1-carbaldehyde, 2-tert-butyl-1-cyclohexyl acetate, styrallyl acetate, allyl (2-methylbutoxy)acetate, 4-methyl-3-decen-5-ol, diphenyl ether, (Z)-3-hexen-1-ol and/or 1-(5,5-dimethyl-1-cyclohexen-1-yl)-4-penten-1-one;
Musk ingredients: 1,4-dioxa-5,17-cycloheptadecanedione, (Z)-4-cyclopentadecen-1-one, 3-methylcyclopentadecanone, 1-oxa-12-cyclohexadecen-2-one, 1-oxa-13-cyclohexadecen-2-one, (9Z)-9-cycloheptadecen-1-one, 2-{1S)-1-[(1R)-3,3-dimethylcyclohexyl]ethoxy}-2-oxoethyl propionate 3-methyl-5-cyclopentadecen-1-one, 1,3,4,6,7,8-hexahydro-4,6,6,7,8,8-hexamethyl-cyclopenta-g-2-benzopyrane, (1S,1′R)-2-[1-(3′,3′-dimethyl-1′-cyclohexyl)ethoxy]-2-methylpropyl propanoate, oxacyclohexadecan-2-one and/or (1S,1′R)-[1-(3′,3′-dimethyl-1′-cyclohexyl)ethoxycarbonyl]methyl propanoate;
Woody ingredients: 1-[(1RS,6SR)-2,2,6-trimethylcyclohexyl]-3-hexanol, 3,3-dimethyl-5-[(1R)-2,2,3-trimethyl-3-cyclopenten-1-yl]-4-penten-2-ol, 3,4′-dimethylspiro[oxirane-2,9′-tricyclo[6.2.1.0^{2,7}]undec[4]ene, (1-ethoxyethoxy)cyclododecane, 2,2,9,11-tetramethylspiro[5.5]undec-8-en-1-yl acetate, 1-(octahydro-2,3,8,8-tetramethyl-2-naphtalenyl)-1-ethanone, patchouli oil, terpenes fractions of patchouli oil, Clearwood®, (1′R, E)-2-ethyl-4-(2′,2′,3′-trimethyl-3′-cyclopenten-1′-yl)-2-buten-1-ol, 2-ethyl-4-(2,2,3-trimethyl-3-cyclopenten-1-yl)-2-buten-1-ol, methyl cedryl ketone, 5-(2,2,3-trimethyl-3-cyclopentenyl)-3-methylpentan-2-ol, 1-(2,3,8,8-tetramethyl-1,2,3,4,6,7,8,8a-octahydronaphthalen-2-yl)ethan-1-one and/or isobornyl acetate;
Other ingredients (e.g. amber, powdery spicy or watery): dodecahydro-3a,6,6,9a-tetramethyl-naphtho[2,1-b]furan and any of its stereoisomers, heliotropin, anisic aldehyde, eugenol, cinnamic aldehyde, clove oil, 3-(1,3-benzodioxol-5-yl)-2-methylpropanal, 7-methyl-2H-1,5-benzodioxepin-3(4H)-one, 2,5,5-trimethyl-1,2,3,4,4a,5,6,7-octahydro-2-naphthalenol, 1-phenylvinyl acetate, 6-methyl-7-oxa-1-thia-4-azaspiro[4.4]nonan and/or 3-(3-isopropyl-1-phenyl)butanal.

According to an embodiment, the perfuming formulation comprises a fragrance modulator (that can be used in addition to the hydrophobic solvent when present or as substitution of the hydrophobic solvent when there is no hydrophobic solvent).

Preferably, the fragrance modulator is defined as a fragrance material with
i. a vapor pressure of less than 0.0008 Torr at 22° C.;
ii. a clog P of 3.5 and higher, preferable 4.0 and higher and more preferable 4.5
iii. at least two Hansen solubility parameters selected from a first group consisting of: an atomic dispersion force from 12 to 20, a dipole moment from 1 to 7, and a hydrogen bonding from 2.5 to 11,
iv. at least two Hansen solubility parameters selected from a second group consisting of: an atomic dispersion force from 14 to 20, a dipole moment from 1 to 8, and a hydrogen bonding from 4 to 11, when in solution with a compound having a vapor pressure range of 0.0008 to 0.08 Torr at 22° C.

Preferable as examples the following ingredients can be listed as modulators but the list in not limited to the following materials: alcohol C12, oxacyclohexadec-12/13-en-2-one, 3-[(2′,2′,3′-trimethyl-3′-cyclopenten-1′-yl)methoxy]-2-butanol, cyclohexadecanone, (Z)-4-cyclopentadecen-1-one, cyclopentadecanone, (8Z)-oxacycloheptadec-8-en-2-one, 2-[5-(tetrahydro-5-methyl-5-vinyl-2-furyl)-tetrahydro-5-methyl-2-furyl]-2-propanol, muguet aldehyde, 1,5,8-trimethyl-13-oxabicyclo[10.1.0]trideca-4,8-diene, (+−)-4,6,6,7,8,8-hexamethyl-1,3,4,6,7,8-hexahydrocyclopenta[g]isochromene, (+)-(1S,2S,3S,5R)-2,6,6-trimethylspiro[bicyclo[3.1.1]heptane-3,1′-cyclohexane]-2′-en-4′-one, oxacyclohexadecan-2-one, 2-{(1S)-1-[(1R)-3,3-dimethylcyclohexyl]ethoxy}-2-oxoethyl propionate, (+)-(4R,4aS,6R)-4,4a-dimethyl-6-(1-propen-2-yl)-4,4a,5,6,7,8-hexahydro-2(3H)-naphthalenone, amylcinnamic aldehyde, hexylcinnamic aldehyde, hexyl salicylate, (1E)-1-(2,6,6-trimethyl-1-cyclohexen-1-yl)-1,6-heptadien-3-one, (9Z)-9-cycloheptadecen-1-one.

A perfumery base according to the invention may not be limited to the above mentioned perfuming ingredients, and many other of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of perfumery. It is also understood that said ingredients may also be compounds known to release in a controlled manner various types of perfuming compounds also known as properfume or profragrance. Non-limiting examples of suitable properfume may include 4-(dodecylthio)-4-(2,6,6-trimethyl-2-cyclohexen-1-yl)-2-butanone, 4-(dodecylthio)-4-(2,6,6-trimethyl-1-cyclohexen-1-yl)-2-butanone, trans-3-(dodecylthio)-1-(2,6,6-trimethyl-3-cyclohexen-1-yl)-1-butanone, 2-phenylethyl oxo(phenyl)acetate or a mixture thereof.

In a particular embodiment, the perfume formulation comprises a perfume oil which has at least one, preferably at least two of the following characteristics:
at least 35%, preferably at least 40%, preferably at least 50%, more preferably at least 60% of perfuming ingredients having a log P above 3, preferably above 3.5,
at least 20%, preferably at least 25%, preferably at least 30%, more preferably at least 40% of Bulky materials of groups 1 to 6, preferably 3 to 6 as herein defined and
at least 15%, preferably at least 20%, more preferably at least 25%, even more preferably at least 30% of high impact perfume materials having a Log T<−4,

In a particular embodiment, the perfume formulation comprises a perfume oil which has all of the following characteristics:
at least 35%, preferably at least 40%, preferably at least 50%, more preferably at least 60% of perfuming ingredients having a log P above 3, preferably above 3.5,
at least 20%, preferably at least 25%, preferably at least 30%, more preferably at least 40% of Bulky materials of groups 1 to 6, preferably 3 to 6 as herein defined and
at least 15%, preferably at least 20%, more preferably at least 25%, even more preferably at least 30% of high impact perfume materials having a Log T<−4,

The amounts of ingredients/materials of the perfume oil defined above are given based on the total weight of the perfume oil.

In a particular embodiment, the perfume oil comprises at least 40% of perfuming ingredients having a log P above 3.

Log P is the common logarithm of estimated octanol-water partition coefficient, which is known as a measure of lipophilicity.

The Log P values of many perfuming compound have been reported, for example, in the Pomona92 database, available from Daylight Chemical Information Systems, Inc. (Daylight CIS), Irvine, Calif., which also contains citations to the original literature. Log P values are most conveniently calculated by the “C LOG P” program, also available from Daylight CIS. This program also lists experimental log P values when they are available in the Pomona92 database. The “calculated log P” (c Log P) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990). The fragment approach is based on the chemical structure of each perfume oil ingredient, and takes into account the numbers and types of atoms, the atom connectivity, and chemical bonding. The c Log P values, which are the most reliable and widely used estimates for this physicochemical property, are preferably used instead of the experimental Log P values in the selection of perfuming compounds which are useful in the present invention.

In a particular embodiment, the perfume oil comprises at least 40%, preferably at least 50%, more preferably at least 60% of ingredients having a log P above 3, preferably above 3.5 and even more preferably above 3.75.

Preferably, the perfume oil contains less than 10% of its own weight of primary alcohols, less than 15% of its own weight of secondary alcohols and less than 20% of its own weight of tertiary alcohols. Advantageously, the perfume used in the invention does not contain any primary alcohols and contains less than 15% of secondary and tertiary alcohols.

In a particular embodiment, the perfume oil comprises at least 20%, preferably at least 25%, more preferably at least 30%, more preferably at least 40% of Bulky materials of groups 1 to 6, preferably 3 to 6.

The Bulky materials are in particular those from one of the following groups:
Group 1: perfuming ingredients comprising a cyclohexane, cyclohexene, cyclohexanone or cyclohexenone ring substituted with at least one 1 to 4 nodes comprising substituent, preferably at least one linear or branched C1 to C4 alkyl or alkenyl substituent;
Group 2: perfuming ingredients comprising a cyclopentane, cyclopentene, cyclopentanone or cyclopentenone ring substituted with at least one 4 or more nodes comprising substituent, preferably at least one linear or branched C₄ or longer, preferably C₄ to C₈ alkyl or alkenyl substituent;
Group 3: perfuming ingredients comprising a phenyl ring or perfuming ingredients comprising a cyclohexane, cyclohexene, cyclohexanone or cyclohexenone ring substituted with at least one 5 or more nodes comprising substituent, preferably at least one linear or branched C₅ or longer, preferably C₅ to C₈, alkyl or alkenyl substituent, or with at least one phenyl substituent and optionally one or more 1 to 3 nodes comprising substituents, preferably one or more linear or branched C₁ to C₃ alkyl or alkenyl substituents;
Group 4: perfuming ingredients comprising at least two fused or linked 5 membered or 6 membered rings, preferably at least two fused or linked C₅ and/or C₆ rings;
Group 5: perfuming ingredients comprising a camphor-like ring structure, i.e. two 5 or 6 membered rings that are fused in a bridge-type fashion;
Group 6: perfuming ingredients comprising at least one 7 to 20 membered ring, preferably at least one C7 or C20 ring structure.

The term nodes as understood in this context means any atom which is able to provide at least two, preferably at least 3, more preferably 4, bonds to further atoms. Particular examples of nodes as herein understood are carbon atoms (up to 4 bonds to further atoms), nitrogen atoms (up to 3 bonds to further atoms), oxygen atoms (up to 2 bonds to further atoms) and sulfur (up to 2 bonds to further atoms). Particular examples of further atoms as understood in this context could be carbon atoms, nitrogen atoms, sulfur atoms, oxygen atoms and hydrogen atoms.

Examples of ingredients from each of these groups are:
Group 1: 2,4-dimethyl-3-cyclohexene-1-carbaldehyde (origin: Firmenich SA, Geneva, Switzerland), isocyclocitral, menthone, isomenthone, Romascone® (methyl 2,2-dimethyl-6-methylene-1-cyclohexanecarboxylate, origin: Firmenich SA, Geneva, Switzerland), nerone, terpineol, dihydroterpineol, hexylate, rose oxide, Perycorolle® ((S)-1,8-p-menthadiene-7-ol, origin: Firmenich SA, Geneva, Switzerland), 1-p-menthene-4-ol, (1 RS,3RS,4SR)-3-p-mentanyl acetate, cyclohexyl acetate, 2,4,6-trimethyl-3-cyclohexene-1-carbaldehyde, para tert-butylcyclohexanone, menthenethiol, 2-tert-butyl-1-cyclohexyl acetate (origin: International Flavors and Fragrances, USA), Lorysia® (4-(1,1-dimethylethyl)-1-cyclohexyl acetate, origin: Firmenich SA, Geneva, Switzerland);
Group 2: (E)-3-methyl-5-(2,2,3-trimethyl-3-cyclopenten-1-yl)-4-penten-2-ol (origin: Givaudan SA, Vernier, Switzerland), (1′R,E)-2-ethyl-4-(2′,2′,3′-trimethyl-3′-cyclopenten-1-yl)-2-buten-1-ol (origin: Firmenich SA, Geneva, Switzerland), Polysantol® ((1′R,E)-3,3-dimethyl-5-(2′,2′,3′-trimethyl-3′-cyclopenten-1′-yl)-4-penten-2-ol, origin: Firmenich SA, Geneva, Switzerland), fleuramone, Hedione® HC (methyl-cis-3-oxo-2-pentyl-1-cyclopentane acetate, origin: Firmenich SA, Geneva, Switzerland), Veloutone® (2,2,5-Trimethyl-5-pentyl-1-cyclopentanone, origin: Firmenich SA, Geneva, Switzerland), Nirvanol® (3,3-dimethyl-5-(2,2,3-trimethyl-3-cyclopenten-1-yl)-4-penten-2-ol, origin: Firmenich SA, Geneva, Switzerland), 3-methyl-5-(2,2,3-trimethyl-3-cyclopenten-1-yl)-2-pentanol (origin, Givaudan SA, Vernier, Switzerland), dartanol, fructone;
Group 3: Neobutenone® (1-(5,5-dimethyl-1-cyclohexen-1-yl)-4-penten-1-one, origin: Firmenich SA, Geneva, Switzerland), nectalactone ((1′R)-2-[2-(4′-methyl-3′-cyclohexen-1′-yl)propyl]cyclopentanone), Dynascone® (mixture of 1-(5,5-dimethyl-1-cyclohexen-1-yl)-4-penten-1-one and 1-(3,3-dimethyl-1-cyclohexen-1-yl)-4-penten-1-one, origin: Firmenich SA, Geneva, Switzerland), Romandolide® ((1S,1′R)-[1-(3′,3′-Dimethyl-1′-cyclohexyl)ethoxycarbonyl]methyl propanoate, origin: Firmenich SA, Geneva, Switzerland), Limbanol® (1-(2,2,3,6-tetramethyl-cyclohexyl)-3-hexanol, origin: Firmenich SA, Geneva, Switzerland), trans-1-(2,2,6-trimethyl-1-cyclohexyl)-3-hexanol (origin: Firmenich SA, Geneva, Switzerland), (E)-3-methyl-4-(2,6,6-trimethyl-2-cyclohexen-1-yl)-3-buten-2-one, terpenyl isobutyrate, 8-methoxy-1-p-menthene, Helvetolide® ((1S,1′R)-2-[1-(3′,3′-dimethyl-1′-cyclohexyl) ethoxy]-2-methylpropyl propanoate, origin: Firmenich SA, Geneva, Switzerland), 1-methyl-4-(4-methyl-3-pentenyl)-3-cyclohexene-1-carbaldehyde, allyl cyclohexylpropionate, 2-methoxy-4-methylphenyl methyl carbonate, ethyl 2-methoxy-4-methylphenyl carbonate, 4-ethyl-2-methoxyphenyl methyl carbonate, Doremox® (tetrahydro-4-methyl-2-phenyl-2H-pyran, origin: Firmenich SA, Geneva, Switzerland), 2,4,6-trimethyl-4-phenyl-1,3-dioxane, terpenyl acetate, dihydroterpenyl acetate, cyclanol acetate, Fructalate® (1,4-cyclohexane diethyldicarboxylate, origin: Firmenich SA, Geneva, Switzerland), alpha-ionone, beta-ionone, damascenone, damascones, Floralozone, Peonile, amylcinnamic aldehdye, hexylcinnamic aldehyde, benzyl cinnamate, amyl salicylate, hexyl salicylate, MPGE (=ethyl 2,3-epoxy-3-phenylbutanoate), Dorysane;
Group 4: vetyverone, 1-(octahydro-2,3,8,8-tetramethyl-2-naphtalenyl)-1-ethanone (origin: International Flavors and Fragrances, USA), (5RS,9RS,10SR)-2,6,9,10-tetramethyl-1-oxaspiro[4.5]deca-3,6-diene and the (5RS,9SR,10RS) isomer, 6-ethyl-2,10,10-trimethyl-1-oxaspiro[4.5]deca-3,6-diene, 1,2,3,5,6,7-hexahydro-1,1,2,3,3-pentamethyl-4-indenone (origin: International Flavors and Fragrances, USA), Hivernal® (a mixture of 3-(3,3-dimethyl-5-indanyl)propanal and 3-(1,1-dimethyl-5-indanyl)propanal, origin: Firmenich SA, Geneva, Switzerland), Polywood® (perhydro-5,5,8A-trimethyl-2-naphthalenyl acetate, origin: Firmenich SA, Geneva, Switzerland), octalynol, Cetalox® (dodecahydro-3a,6,6,9a-tetramethyl-naphtho[2,1-b]furan, origin: Firmenich SA, Geneva, Switzerland), Koumalactone® ((3ARS,6SR,7ASR)-perhydro-3,6-dimethyl-benzo[B]furan-2-one, origin: Firmenich SA, Geneva, Switzerland), Natactone® ((6R)-perhydro-3,6-dimethyl-benzo[B]furan-2-one, origin: Firmenich SA, Geneva, Switzerland), yara yara, bromelia, heliopropanal, octahydrocoumarine, galaxolide;
Group 5: camphor, borneol, isobornyl acetate, 8-isopropyl-6-methyl-bicyclo[2.2.2]oct-5-ene-2-carbaldehyde, Florex® (mixture of 9-ethylidene-3-oxatricyclo[6.2.1.0(2,7)]undecan-4-one and 10-ethylidene-3-oxatricyclo[6.2.1.0(2,7)]undecan-4-one, origin: Firmenich SA, Geneva, Switzerland), (1R,2S,4R)-4,6,6-trimethyl-bicyclo[3,1,1]heptan-2-ol, nopyl acetate, patchoulol, tricyclo[5.2.1.0(2,6)]dec-3-en-8-yl acetate and tricyclo[5.2.1.0(2,6)]dec-4-en-8-yl acetate as well as tricyclo[5.2.1.0(2,6)]dec-3-en-8-yl propanoate and tricyclo[5.2.1.0(2,6)]dec-4-en-8-yl propanoate, eucalyptol, Rhubofix® (3′,4-dimethyl-tricyclo[6.2.1.0(2,7)]undec-4-ene-9-spiro-2′-oxirane, origin: Firmenich SA, Geneva, Switzerland), 9/10-ethyldiene-3-oxatricyclo[6.2.1.0(2,7)]undecane, Verdylate, (+)-(1S,2S,3S)-2,6,6-trimethyl-bicyclo[3.1.1]heptane-3-spiro-2′-cyclohexen-4′-one
Group 6: Cedroxyde® (trimethyl-13-oxabicyclo-[10.1.0]-trideca-4,8-diene, origin: Firmenich SA, Geneva, Switzerland), Ambrettolide LG ((E)-9-hexadecen-16-olide, origin: Firmenich SA, Geneva, Switzerland), Habanolide® (pentadecenolide, origin: Firmenich SA, Geneva, Switzerland), muscenone (3-methyl-(4/5)-cyclopentadecenone, origin: Firmenich SA, Geneva, Switzerland), muscone (origin: Firmenich SA, Geneva, Switzerland), Exaltolide® (pentadecanolide, origin: Firmenich SA, Geneva, Switzerland), Exaltone® (cyclopentadecanone, origin: Firmenich SA, Geneva, Switzerland), (1-ethoxyethoxy)cyclododecane (origin: Firmenich SA, Geneva, Switzerland), Astrotone, 4,8-cyclododecadien-1-one, Methyl cedryl ketone (origin: International Flavors and Fragrances, USA), vetyverol, cedramber (8-methoxy-2,6,6,8-tetramethyl-tricyclo[5.3.1.0(1,5)]undecane, origin: Firmenich SA, Geneva, Switzerland), cedrene, cedrenol, cedrol, 3-methoxy-7,7-dimethyl-10-methylene-bicyclo[4.3.1]decane (origin: Firmenich SA, Geneva, Switzerland).

Preferably, the perfume oil comprises at least 25%, preferably at least 30%, preferably at least 40%, preferably at least 50%, more preferably at least 60% of ingredients selected from Groups 1 to 6, as defined above. More preferably said perfume comprises at least 30%, preferably at least 40%, preferably at least 50% of ingredients from Groups 3 to 6, as defined above. Most preferably said perfume comprises at least 30%, preferably at least 50% of ingredients from Groups 3, 4, 6, as defined above.

In a particular embodiment, the perfume oil comprises at least 15% of high impact perfume materials having a Log T<−4.

“High impact perfume raw materials” should be understood as perfume raw materials having a Log T<−4. The odor threshold concentration of a chemical compound is determined in part by its shape, polarity, partial charges and molecular mass. For convenience, the threshold concentration is presented as the common logarithm of the threshold concentration, i.e., Log [Threshold] (“Log T”).

The odor threshold concentration of a perfuming compound is determined by using a gas chromatograph (“GC”). Specifically, the gas chromatograph is calibrated to determine the exact volume of the perfume oil ingredient injected by the syringe, the precise split ratio, and the hydrocarbon response using a hydrocarbon standard of known concentration and chain-length distribution. The air flow rate is accurately measured and, assuming the duration of a human inhalation to last 12 seconds, the sampled volume is calculated. Since the precise concentration at the detector at any point in time is known, the mass per volume inhaled is known and hence the concentration of the perfuming compound. To determine the threshold concentration, solutions are delivered to the sniff port at the back-calculated concentration. A panelist sniffs the GC effluent and identifies the retention time when odor is noticed. The average across all panelists determines the odor threshold concentration of the perfuming compound. The determination of odor threshold is described in more detail in C. Vuilleumier et al., Multidimensional Visualization of Physical and Perceptual Data Leading to a Creative Approach in Fragrance Development, Perfume & Flavorist, Vol. 33, September, 2008, pages 54-61.

According to a particular embodiment, the high impact perfume raw materials having a Log T<−4 are selected from the list in Table A below.

TABLE A
high impact perfume raw materials having a Log T <− 4
Perfume raw materials (Log T <− 4)
(+−)-1-METHOXY-3-HEXANETHIOL
4-(4-HYDROXY-1-PHENYL)-2-BUTANONE
(+−)-2-(4-METHYL-3-CYCLOHEXEN-1-YL)-2-PROPANETHIOL
2-METHOXY-4-(1-PROPENYL)-1-PHENYL ACETATE
PYRAZOBUTYLE
3-PROPYLPHENOL
1-(3-METHYL-1-BENZOFURAN-2-YL)ETHANONE
2-(3-PHENYLPROPYL)PYRIDINE
1-(3,3-DIMETHYL-1-CYCLOHEXEN-1-YL)-4-PENTEN-1-ONE (A) + 1-
(5,5-DIMETHYL-1-CYCLOHEXEN-1-YL)-4-PENTEN-1-ONE (B)
1-(5,5-DIMETHYL-1-CYCLOHEXEN-1-YL)-4-PENTEN-1-ONE
(3RS,3ARS,6SR,7ASR)-PERHYDRO-3,6-DIMETHYL-
BENZO[B]FURAN-2-ONE (A) + (3SR,3ARS,6SR,7ASR)-PERHYDRO-
3,6-DIMETHYL-BENZO[B]FURAN-2-ONE (B)
(+−)-1-(5-ETHYL-5-METHYL-1-CYCLOHEXEN-1-YL)-4-PENTEN-1-
ONE
(1′S,3′R)-1-METHYL-2-[(1′,2′,2′-TRIMETHYLBICYCLO[3.1.0]HEX-3′-
YL)METHYL]CYCLOPROPYL}METHANOL
(+−)-3-MERCAPTOHEXYL ACETATE
(2E)-1-(2,6,6-TRIMETHYL-1,3-CYCLOHEXADIEN-1-YL)-2-BUTEN-1-
ONE
7-METHYL-2H-1,5-BENZODIOXEPIN-3(4H)-ONE
(2E,6Z)-2,6-NONADIEN-1-OL
(4Z)-4-DODECENAL
(+−)-4-HYDROXY-2,5-DIMETHYL-3(2H)-FURANONE
METHYL 2,4-DIHYDROXY-3,6-DIMETHYLBENZOATE
3-METHYLINDOLE
(+−)-PERHYDRO-4ALPHA,8ABETA-DIMETHYL-4A-NAPHTHALENOL
PATCHOULOL
2-METHOXY-4-(1-PROPENYL)PHENOL
(+−)-5,6-DIHYDRO-4-METHYL-2-PHENYL-2H-PYRAN (A) +
TETRAHYDRO-4-METHYLENE-2-PHENYL-2H-PYRAN (B)
4-METHYLENE-2-PHENYLTETRAHYDRO-2H-PYRAN (A) + (+−)-4-
METHYL-2-PHENYL-3,6-DIHYDRO-2H-PYRAN (B)
4-HYDROXY-3-METHOXYBENZALDEHYDE
NONYLENIC ALDEHYDE
2-METHOXY-4-PROPYLPHENOL
(2Z)-3-METHYL-5-PHENYL-2-PENTENENITRILE (A) + (2E)-3-
METHYL-5-PHENYL-2-PENTENENITRILE (B)
1-(SPIRO[4.5]DEC-6-EN-7-YL)-4-PENTEN-1-ONE (A) + 1-
(SPIRO[4.5]DEC-7-EN-7-YL)-4-PENTEN-1-ONE(B)
2-METHOXYNAPHTHALENE
(−)-(3AR,5AS,9AS,9BR)-3A,6,6,9A-
TETRAMETHYLDODECAHYDRONAPHTHO[2,1-B]FURAN
5-NONANOLIDE
(3AR,5AS,9AS,9BR)-3A,6,6,9A-
TETRAMETHYLDODECAHYDRONAPHTHO[2,1-B]FURAN
7-ISOPROPYL-2H,4H-1,5-BENZODIOXEPIN-3-ONE
COUMARIN
4-METHYLPHENYL ISOBUTYRATE
(2E)-1-(2,6,6-TRIMETHYL-1,3-CYCLOHEXADIEN-1-YL)-2-BUTEN-1-
ONE
BETA,2,2,3-TETRAMETHYL-DELTA-METHYLENE-3-
CYCLOPENTENE-1-BUTANOL
DELTA DAMASCONE ((2E)-1-[(1RS,2SR)-2,6,6-TRIMETHYL-3-
CYCLOHEXEN-1-YL]-2-BUTEN-1-ONE)
(+−)-3,6-DIHYDRO-4,6-DIMETHYL-2-PHENYL-2H-PYRAN
ANISALDEHYDE
PARACRESOL
3-ETHOXY-4-HYDROXYBENZALDEHYDE
METHYL 2-AMINOBENZOATE
ETHYL METHYLPHENYLGLYCIDATE
OCTALACTONE G
ETHYL 3-PHENYL-2-PROPENOATE
(−)-(2E)-2-ETHYL-4-[(1R)-2,2,3-TRIMETHYL-3-CYCLOPENTEN-1-YL]-
2-BUTEN-1-OL
PARACRESYL ACETATE
DODECALACTONE
TRICYCLONE
(+)-(3R,5Z)-3-METHYL-5-CYCLOPENTADECEN-1-ONE
UNDECALACTONE
(1R,4R)-8-MERCAPTO-3-P-MENTHANONE
(3S,3AS,6R,7AR)-3,6-DIMETHYLHEXAHYDRO-1-BENZOFURAN-
2(3H)-ONE
BÉTA IONONE
(+−)-6-PENTYLTETRAHYDRO-2H-PYRAN-2-ONE
(3E,5Z)-1,3,5-UNDECATRIENE
10-UNDECENAL (A) + (9E)-9-UNDECENAL (B) + (9Z)-9-UNDECENAL
(C)
(Z)-4-DECENAL
(+−)-ETHYL 2-METHYLPENTANOATE
1,2-DIALLYLDISULFANE
(2Z)-2-TRIDECENENITRILE (A) + (3Z)-3-TRIDECENENITRILE (B) +
(3E)-3-TRIDECENENITRILE (C) + (2E)-2-TRIDECENENITRILE (D)
(+−)-2-ETHYL-4,4-DIMETHYL-1,3-OXATHIANE
(+)-(3R,5Z)-3-METHYL-5-CYCLOPENTADECEN-1-ONE
3-(4-TERT-BUTYLPHENYL)PROPANAL
ALLYL (CYCLOHEXYLOXY)ACETATE
METHYLNAPHTHYLKETONE
(+−)-(4E)-3-METHYL-4-CYCLOPENTADECEN-1-ONE (A) + (+−)-(5E)-3-
METHYL-5-CYCLOPENTADECEN-1-ONE (B) + (+−)-(5Z)-3-METHYL-5-
CYCLOPENTADECEN-1-ONE (C)
CYCLOPROPYLMETHYL(3Z)-3-HEXENOATE(A) +
CYCLOPROPYLMETHYL (3E)-3-HEXENOATE (B)
(4E)-4-METHYL-5-(4-METHYLPHENYL)-4-PENTENAL
(+−)-1-(5-PROPYL-1,3-BENZODIOXOL-2-YL)ETHANONE
4-METHYL-2-PENTYLPYRIDINE
(+−)-(E)-3-METHYL-4-(2,6,6-TRIMETHYL-2-CYCLOHEXEN-1-YL)-3-
BUTEN-2-ONE
(3ARS,5ASR,9ASR,9BRS)-3A,6,6,9A-
TETRAMETHYLDODECAHYDRONAPHTHO[2,1-B]FURAN
(2S,5R)-5-METHYL-2-(2-PROPANYL)CYCLOHEXANONE OXIME
6-HEXYLTETRAHYDRO-2H-PYRAN-2-ONE
(+−)-3-(3-ISOPROPYL-1-PHENYL)BUTANAL
METHYL 2-((1RS,2RS)-3-OXO-2-PENTYLCYCLOPENTYL)ACETATE
(A) + METHYL 2-((1RS,2SR)-3-OXO-2-
PENTYLCYCLOPENTYL)ACETATE (B)
1-(2,6,6-TRIMETHYL-1-CYCLOHEX-2-ENYL)PENT-1-EN-3-ONE
INDOL
7-PROPYL-2H,4H-1,5-BENZODIOXEPIN-3-ONE
ETHYL PRALINE
(4-METHYLPHENOXY)ACETALDEHYDE
ETHYL TRICYCLO[5.2.1.0.(2,6)]DECANE-2-CARBOXYLATE
(+)-(1′S,2S,E)-3,3-DIMETHYL-5-(2′,2′,3′-TRIMETHYL-3′-
CYCLOPENTEN-1′-YL)-4-PENTEN-2-OL
(2R,4E)-3,3-DIMETHYL-5-[(1 R)-2,2,3-TRIMETHYL-3-CYCLOPENTEN-
1-YL]-4-PENTEN-2-OL (A) + (2S,4E)-3,3-DIMETHYL-5-[(1R)-2,2,3-
TRIMETHYL-3-CYCLOPENTEN-1-YL]-4-PENTEN-2-OL (B)
8-ISOPROPYL-6-METHYL-BICYCLO[2.2.2]OCT-5-ENE-2-
CARBALDEHYDE
METHYLNONYLACETALDEHYDE
4-FORMYL-2-METHOXYPHENYL 2-METHYLPROPANOATE
(E)-4-DECENAL
(+−)-2-ETHYL-4-(2,2,3-TRIMETHYL-3-CYCLOPENTEN-1-YL)-2-
BUTEN-1-OL
(1R,5R)-4,7,7-TRIMETHYL-6-THIABICYCLO[3.2.1]OCT-3-ENE (A) +
(1 R,4R,5R)-4,7,7-TRIMETHYL-6-THIABICYCLO[3.2.1]OCTANE (B)
(-)-(3R)-3,7-DIMETHYL-1,6-OCTADIEN-3-OL
(E)-3-PHENYL-2-PROPENENITRILE
4-METHOXYBENZYL ACETATE
(E)-3-METHYL-5-(2,2,3-TRIMETHYL-3-CYCLOPENTEN-1-YL)-4-
PENTEN-2-OL
ALLYL (3-METHYLBUTOXY)ACETATE (A) + (+−)-ALLYL (2-
METHYLBUTOXY)ACETATE
(+−)-(2E)-1-(2,6,6-TRIMETHYL-2-CYCLOHEXEN-1-YL)-2-BUTEN-1-
ONE
(1E)-1-(2,6,6-TRIMETHYL-1-CYCLOHEXEN-1-YL)-1-PENTEN-3-ONE

According to an embodiment, perfume raw materials having a Log T<−4 are chosen in the group consisting of aldehydes, ketones, alcohols, phenols, esters lactones, ethers, epoxydes, nitriles and mixtures thereof.

According to an embodiment, perfume raw materials having a Log T<−4 comprise at least one compound chosen in the group consisting of alcohols, phenols, esters lactones, ethers, epoxydes, nitriles and mixtures thereof, preferably in amount comprised between 20 and 70% by weight based on the total weight of the perfume raw materials having a Log T<−4.

According to an embodiment, perfume raw materials having a Log T<−4 comprise between 20 and 70% by weight of aldehydes, ketones, and mixtures thereof based on the total weight of the perfume raw materials having a Log T<−4.

The remaining perfume raw materials contained in the oil-based core may have therefore a Log T>−4.

Non limiting examples of perfume raw materials having a Log T>−4 are listed in table B below.

TABLE B
perfume raw materials having a Log T >− 4
Perfume raw materials (Log T >− 4)
ETHYL 2-METHYLBUTYRATE
(E)-3-PHENYL-2-PROPENYL ACETATE
(+−)-8-SEC-BUTYLQUINOLINE (A) + (+−)-6-SEC-BUTYLQUINOLINE
(+−)-3-(1,3-BENZODIOXOL-5-YL)-2-METHYLPROPANAL
VERDYLE PROPIONATE
1-(OCTAHYDRO-2,3,8,8-TETRAMETHYL-2-NAPHTALENYL)-1-ETHANONE
METHYL 2-((1 RS,2RS)-3-OXO-2-PENTYLCYCLOPENTYL)ACETATE
(+−)-(E)-4-METHYL-3-DECEN-5-OL
2,4-DIMETHYL-3-CYCLOHEXENE-1-CARBALDEHYDE
1,3,3-TRIMETHYL-2-OXABICYCLO[2.2.2]OCTANE
TETRAHYDRO-4-METHYL-2-(2-METHYL-1-PROPENYL)-2H-PYRAN
ALDEHYDEC 12
1-OXA-12-CYCLOHEXADECEN-2-ONE (A) + 1-OXA-13-
CYCLOHEXADECEN-2-ONE (B)
(+−)-3-(4-ISOPROPYLPHENYL)-2-METHYLPROPANAL
ALDEHYDE C 11 LENIQUE
(+−)-2,6-DIMETHYL-7-OCTEN-2-OL
(+−)-2,6-DIMETHYL-7-OCTEN-2-OL
ALLYL 3-CYCLOHEXYLPROPANOATE
(Z)-3-HEXENYL ACETATE
(2RS,5SR)-5-METHYL-2-(2-PROPANYL)CYCLOHEXANONE (A) +
(2RS,5RS)-5-METHYL-2-(2-PROPANYL)CYCLOHEXANONE (B)
ALLYL HEPTANOATE
(1RS,2RS)-2-(2-METHYL-2-PROPANYL)CYCLOHEXYL ACETATE (A) +
(1RS,2SR)-2-(2-METHYL-2-PROPANYL)CYCLOHEXYL ACETATE (B)
1,1-DIMETHYL-2-PHENYLETHYL BUTYRATE
GERANYL ACETATE (A) + NERYL ACETATE (B)
(+−)-1-PHENYLETHYL ACETATE
1,1-DIMETHYL-2-PHENYLETHYL ACETATE
3-METHYL-2-BUTENYL ACETATE
ETHYL 3-OXOBUTANOATE (A) <=> (2Z)-ETHYL 3-HYDROXY-2-
BUTENOATE (B)
8-P-MENTHANOL
8-P-MENTHANYL ACETATE (A) + 1-P-MENTHANYL ACETATE (B)
(+−)-2-(4-METHYL-3-CYCLOHEXEN-1-YL)-2-PROPANYL ACETATE
(+−)-2-METHYLBUTYL BUTANOATE
2-{(1S)-1-[(1R)-3,3-DIMETHYLCYCLOHEXYL]ETHOXY}-2-OXOETHYL
PROPIONATE
3,5,6-TRIMETHYL-3-CYCLOHEXENE-1-CARBALDEHYDE (A) + 2,4,6-
TRIMETHYL-3-CYCLOHEXENE-1-CARBALDEHYDE (B)
2-CYCLOHEXYLETHYL ACETATE
ALDEHYDE C 8
ETHYL BUTANOATE
(+−)-(3E)-4-(2,6,6-TRIMETHYL-2-CYCLOHEXEN-1-YL)-3-BUTEN-2-ONE (A) +
(3E)-4-(2,6,6-TRIMETHYL-1-CYCLOHEXEN-1-YL)-3-BUTEN-2-ONE (B);
1-[(1RS,6SR)-2,2,6-TRIMETHYLCYCLOHEXYL]-3-HEXANOL
1,3,3-TRIMETHYL-2-OXABICYCLO[2.2.2]OCTANE
1,3,3-TRIMETHYL-2-OXABICYCLO[2.2.2]OCTANE
ETHYL HEXANOATE
UNDECANAL
ALDEHYDEC 10
2-PHENYLETHYL ACETATE
(1S,2S,4S)-1,7,7-TRIMETHYLBICYCLO[2.2.1]HEPTAN-2-OL (A) +
(1S,2R,4S)-1,7,7-TRIMETHYLBICYCLO[2.2.1]HEPTAN-2-OL (B)
(+−)-3,7-DIMETHYL-3-OCTANOL
1-METHYL-4-(2-PROPANYLIDENE)CYCLOHEXENE
(+)-(R)-4-(2-METHOXYPROPAN-2-YL)-1-METHYLCYCLOHEX-1-ENE
VERDYL ACETATE
(3R)-1-[(1R,6S)-2,2,6-TRIMETHYLCYCLOHEXYL]-3-HEXANOL (A) + (3S)-1-
[(1R,6S)-2,2,6-TRIMETHYLCYCLOHEXYL]-3-HEXANOL (B) + (3R)-1-
[(1S,6S)-2,2,6-TRIMETHYLCYCLOHEXYL]-3-HEXANOL (C)
(+)-(1S,1′R)-2-[1-(3′,3′-DIMETHYL-1-CYCLOHEXYL)ETHOXY]-2-
METHYLPROPYL PROPANOATE

In a particular embodiment, the perfume oil comprises 0-20 wt % of a density balancing material having a density greater than 1.07 g/cm³.

A “density balancing material” should be understood as a material having a density greater than 1.07 g/cm³ and having preferably low or no odor.

According to an embodiment, the perfume oil comprises 2-75 wt % of a density balancing material having a density greater than 1.07 g/cm³ and 25-98 wt % of a perfume oil comprising at least 15 wt % of high impact perfume raw materials having a Log T<−4.

The density of a component is defined as the ratio between its mass and its volume (g/cm³).

Several methods are available to determine the density of a component.

One may refer for example to the ISO 298:1998 method to measure d20 densities of essential oils.

In a particular embodiment, the density balancing material is chosen in the group consisting of benzyl salicylate, benzyl benzoate, cyclohexyl salicylate, benzyl phenylacetate, phenylethyl phenoxyacetate, triacetin, methyl and ethyl salicylate, benzyl cinnamate, and mixtures thereof.

In a particular embodiment, the density balancing material is chosen in the group consisting of benzyl salicylate, benzyl benzoate, cyclohexyl salicylate and mixtures thereof.

The nature of high impact perfume raw materials having a Log T<−4 and density balancing material having a density greater than 1.07 g/cm³ are described in WO2018115250, the content of which are included by reference.

In a particular embodiment, the hydrophobic solvent has Hansen Solubility Parameters compatible with entrapped perfume oil.

The term “Hansen solubility parameter” is understood refers to a solubility parameter approach proposed by Charles Hansen used to predict polymer solubility and was developed around the basis that the total energy of vaporization of a liquid consists of several individual parts. To calculate the “weighted Hansen solubility parameter” one must combine the effects of (atomic) dispersion forces, (molecular) permanent dipole-permanent dipole forces, and (molecular) hydrogen bonding (electron exchange). The weighted Hansen solubility parameter” is calculated as (δD²+δP²+δH²)^{0.5}, wherein δD is the Hansen dispersion value, δP is the Hansen polarizability value, and δH is the Hansen Hydrogen-bonding (“h-bonding”) value. For a more detailed description of the parameters and values, see Charles Hansen, The Three Dimensional Solubility Parameter and Solvent Diffusion Coefficient, Danish Technical Press (Copenhagen, 1967).

Euclidean difference in solubility parameter between a fragrance and a solvent is calculated as (4*(δDₛₒₗᵥₑₙₜ−δD_{fragrance})²+(δPₛₒₗᵥₑₙₜ−δP_{fragrance})²+(δHₛₒₗᵥₑₙₜ−δH_{fragrance})²)^{0.5}, in which δDₛₒₗᵥₑₙₜ, δPₛₒₗᵥₑₙₜ, and δHₛₒₗᵥₑₙₜ, are the Hansen dispersion value (also referred to in the following as the atomic dispersion force), Hansen polarizability value (also referred to in the following as the dipole moment), and Hansen h-bonding values of the solvent (also referred to in the following as hydrogen bonding), respectively; and δD_{fragrance}, δP_{fragrance}, and δH_{fragrance} are the Hansen dispersion value, Hansen polarizability value, and Hansen h-bonding values of the fragrance, respectively.

In a particular embodiment, the perfume oil and the hydrophobic solvent have at least two Hansen solubility parameters selected from a first group consisting of: an atomic dispersion force (δD) from 12 to 20, a dipole moment (δP) from 1 to 8, and a hydrogen bonding (δH) from 2.5 to 11.

In a particular embodiment, at least 90% of the perfume oil, preferably at least 95% of the perfume oil, most preferably at least of 98% of the perfume oil has at least two Hansen solubility parameters selected from a first group consisting of: an atomic dispersion force (δD) from 12 to 20, a dipole moment (δP) from 1 to 8, and a hydrogen bonding (δH) from 2.5 to 11.

In a particular embodiment, the perfume oil and the hydrophobic solvent have at least two Hansen solubility parameters selected from a second group consisting of: an atomic dispersion force (δD) from 12 to 20, preferably from 14 to 20, a dipole moment (δP) from 1 to 8, preferably from 1 to 7, and a hydrogen bonding (δH) from 2.5 to 11, preferably from 4 to 11.

In a particular embodiment, the perfume formulation comprises optionally other active ingredients.

An active ingredient is not limited and can be chosen in the group consisting of a cosmetic ingredient, skin caring ingredient, perfume ingredient, flavor ingredient, malodour counteracting ingredient, bactericide ingredient, fungicide ingredient, pharmaceutical or agrochemical ingredient, a sanitizing ingredient, an insect repellent or attractant, and mixtures thereof.

In a particular embodiment, perfume formulation and/or free perfume oil 1 as following is excluded from the present invention:

| Raw material | wt % |
|---|---|
| Romascone ®^{a)} | 20 |
| Verdox^{IMb)} | 20 |
| Lorysia ®^{c)} | 20 |
| 3-(4-isopropylphenyl)-2-methylpropanal | 20 |
| Salicynile ®^{d)} | 20 |

^{a)}Methyl 2,2-dimethyl-6-methylene-1-cyclohexanecarboxylate, origin: Firmenich SA, Geneva, Switzerland
^{b)}2-tert-butyl-1-cyclohexyl acetate, trademark from International Flavors & Fragrances, USA
^{c)}4-(1,1-diméthyléthyl)-1-cyclohexyl acetate, origin: Firmenich SA, Geneva, Switzerland
^{d)}(2Z)-2-phenyl-2-hexenenitrile, origin: Firmenich SA, Geneva, Switzerland

In a particular embodiment, perfume formulation and/or free perfume oil 2 as following is excluded from the present invention:

| Raw mat | % in oil |
|---|---|
| Ethyl 2-methyl-pentanoate | 3.20% |
| Eucalyptol | 7.80% |
| 2,4-Dimethyl-3-cyclohexene-1-carbaldehyde ¹⁾ | 0.75% |
| Aldehyde C10 | 0.75% |
| Citronellyl Nitrile | 4.30% |
| Isobornyl acetate | 3.00% |
| Verdox ®²⁾ | 9.80% |
| Citronellyl Acetate | 1.30% |
| 2-Methylundecanal | 3.00% |
| Diphenyloxide | 0.80% |
| Aldehyde C12 | 1.30% |
| Dicyclopentadiene acetate | 9.85% |
| Ionone beta | 3.30% |
| Undecalactone gamma | 18.75% |
| Hexyl Salicylate | 15.90% |
| Benzyl Salicylate | 16.20% |

TOTAL 100%
¹⁾ Origin: Firmenich SA, Swtizwerland
²⁾2-tert-butyl-1-cyclohexyl acetate, origin and trademark from IFF, USA

In a particular embodiment, perfume formulation and/or free perfume oil 3 as following is excluded from the present invention:

| Component | % |
|---|---|
| ACÉTATE DE 4-(1,1-DIMÉTHYLÉTHYL)- | 14.50 |
| 1-CYCLOHEXYLE ¹⁾ | |
| LINALOL BJ | 10.50 |
| LILIAL ®²⁾ | 10.00 |
| ISO E SUPER ³⁾ | 10.00 |
| CITRONELLYL NITRILE | 9.00 |
| DIPHENYLOXYDE | 6.50 |
| ISOBORNYL ACETATE | 6.00 |
| BETA IONONE | 6.00 |
| TRICYCLO[5.2.1.0~2,6~]DEC-3- | 5.50 |
| EN-8-YL ACETATE (A) + | |
| TRICYCLO[5.2.1.0~2,6~]DEC-4- | |
| EN-8-YL ACETATE (B)⁴⁾ | |
| ETHER MT | 4.00 |
| HEDIONE ® ⁵⁾ | 4.00 |
| GERANIOL 60 | 3.00 |
| CITRAL | 2.50 |
| ALDEHYDE C 10 | 2.50 |
| ALLYL HEPTANOATE | 2.50 |
| ETHYL METHYL-2-BUTYRATE | 1.50 |
| GERANYL ACETATE | 1.00 |
| 2,4-DIMETHYL-3-CYCLOHEXENE- | 1.00 |
| 1-CARBALDEHYDE ⁶⁾ | |

¹⁾ Firmenich SA, Switzerland
²⁾3-(4-tert-butylphenyl)-2-methylpropanal, Givaudan SA, Vernier, Switzerland
³⁾ 1-(octahydro-2,3,8,8-tetramethyl-2-naphtalenyl)-1-ethanone, International Flavors & Fragrances, USA
⁴⁾Firmenich SA, Switzerland
⁵⁾ Methyl dihydrojasmonate, Firmenich SA, Switzerland
⁶⁾ Firmenich SA, Switzerland

In a particular embodiment, perfume formulation and/or free perfume oil 4 as following is excluded from the present invention:

| Ingredient | Parts |
|---|---|
| Isopropyl myristate | 0.3 |
| (Z)-3-hexen-1-ol butyrate | 0.6 |
| Delta damascene | 1.0 |
| 2,4-Dimethyl-3-cyclohexene- | 1.0 |
| 1-carbaldehyde | |
| Habanolide ® ¹⁾ | 3.0 |
| Hedione ® ²⁾ | 5.0 |
| Hexyl cinnamic aldehyde | 12.0 |
| Iso E Super ®³⁾ | 16.0 |
| Verdyl acetate | 24.0 |
| Lilial ®⁴⁾ | 37.0 |

¹⁾ Trademark from Firmenich; pentadecenolide, origin: Firmenich SA, Geneva, Switzerland
²⁾ Trademark from Firmenich; Methyl-cis-3-oxo-2-pentyl-1-cyclopentane acetate, origin: Firmenich SA, Geneva, Switzerland
³⁾Trademark from IFF; 7-acetyl, 1,2,3,4,5,6,7,8-octahydro-1,1,6,7-tetramethyl naphthalene
⁴⁾Trademark from Givaudan; 3-(4-tert-butylphenyl)-2-methylpropanal

In a particular embodiment, perfume formulation and/or free perfume oil 5 as following is excluded from the present invention:

| Raw Materials | % in oil |
|---|---|
| 2,4-Dimethyl-3-cyclohexene-1-carbaldehyde | 3.30% |
| Allyl Heptanoate | 5.50% |
| Allyl amyl glycolate | 10.99% |
| Delta Damascone | 1.65% |
| Verdyl acetate | 20.30% |
| Hedione ®¹⁾ | 4.95% |
| Iso E Super ® ²⁾ | 16.49% |
| Ald. Hexylcinnamique | 9.89% |
| Ethyl-2-methylvalerate | 3.3% |
| Lilial LG | 21.98% |
| Butyrate de Pipol | 1.1% |
| Ambrox ®³⁾ | 0.55% |
| Total | 100% |

¹⁾Methyl dihydrojasmonate. Firmenich SA, Geneva, Switzerland
²⁾ 1-(octahydro-2,3,8,8-tetramethyl-2-naphtalenyl)-1-ethanone, International Flavors & Fragrances, USA
³⁾(−)-(8R)-8,12-epoxy-13,14,15,16-tetranorlabdane, Firmenich SA, Geneva, Switzerland

In a particular embodiment, the delivery system has a biodegradability of at least 40%, preferably at least 60%, preferably at least 65%, 70%, 75%, 80%, 85%, 90%, 95% or 98% within 60 days according to OECD301F.

Thereby it is understood that the delivery system including all components, such as the biodegradable carrier and the perfume formulation, have a biodegradability of at least 40%, preferably at least 60%, preferably at least 65%, 70%, 75%, 80%, 85%, 90%, 95% or 98% within 60 days according to OECD301F.

In a particular embodiment, the delivery system has a stability or chemical stability of not more than 40%, preferably not more than 35%, preferably more than 30%, The stability or chemical stability of the delivery system being determined as not more than 40%, preferably not more than 35%, preferably more than 30%, of the perfume leaking out of the microcapsules when incorporated in a consumer product for a particular storage time and temperature, with the microcapsules being stable after 15 days storage at 37° C., more preferably after 30 days storage at 37° C. preferably in fabric softeners, liquid detergents, body washes, deodorants or antiperspirants, for at least 2 weeks storage at 40° C. in body lotions, shampoos or hair conditioners.

Furthermore, the delivery system show a rubbing effect detectable on fresh samples, and preferably after 15 days of storage in application at 37° C., even more preferably after 30 days at 37° C.

Preferably, the laundry composition comprises between 0.1 and 30% by weight of the delivery system as defined above.

According to the present invention, the laundry composition comprises a free perfume oil.

By “free perfume” it is herein understood a perfume or perfume oil which is comprised in the perfuming composition and not entrapped in a delivery system.

In a particular embodiment, the total amount of the delivery system is 0.05 to 5 wt. % (based on the total weight of the perfuming composition) and the total amount of the free perfume oil is 0.05 to 5 wt. % (based on the total weight of the perfuming composition).

In a particular embodiment, the total perfume oil of the perfume formulation entrapped in the delivery system and total free perfume oil are present in the perfuming composition in a weight ratio of 1:20 to 20:1, preferably 10:1 to 1:10.

In a particular embodiment, the free perfume further comprises an active ingredient, preferably chosen in the group consisting of a cosmetic ingredient, skin caring ingredient, perfume ingredient, flavor ingredient, malodour counteracting ingredient, bactericide ingredient, fungicide ingredient, pharmaceutical or agrochemical ingredient, a sanitizing ingredient, an insect repellent or attractant, and mixtures thereof.

According to an embodiment, the laundry composition comprises in addition to the delivery system of the present invention (the first type of delivery system) a second type of delivery system, wherein the first type of delivery system and the second type of delivery system differ in their perfuming formulations and/or carrier material (shell or matrix) and/or outer coating.

In a particular embodiment, the laundry composition can be used in liquid form applicable to liquid laundry composition as well as in powder form, applicable to powder laundry composition.

In a particular embodiment, the liquid laundry composition comprises:
from 2 to 65% by weight, relative to the total weight of the laundry composition, of at least one laundry additive;
free perfume;
water or a water-miscible hydrophilic organic solvent; and
a delivery system as defined herein above.

In a particular embodiment, the powder or solid laundry composition comprises:
from 2 to 65% by weight, relative to the total weight of the laundry composition, of at least one laundry additive;
free perfume; and
a delivery system as defined herein above.

In a particular embodiment, the laundry additives comprise dialkyl quaternary ammonium salts, dialkyl ester quaternary ammonium salts (esterquats), Hamburg esterquat (HEQ), TEAQ (triethanolamine quat), silicones, alkylbenzenesulfonate (ABS), secondary alkyl sulfonate (SAS), primary alcohol sulfate (PAS), lauryl ether sulfate (LES), methyl ester sulfonate (MES) and nonionic surfactant such as alkyl amines, alkanolamide, fatty alcohol poly(ethylene glycol) ether, fatty alcohol ethoxylate (FAE), ethylene oxide (EO) and propylene oxide (PO) copolymers, amine oxydes, alkyl polyglucosides, alkyl polyglucosamides, and mixtures thereof.

In a particular embodiment, the laundry composition is in form of a fabric softener, liquid detergent, solid detergent, solid scent booster, liquid scent booster, unidose liquid detergent, tablet powder detergent, dryer sheets, bleach booster.

In a particular embodiment, the laundry composition is in form of a fabric softener comprising:
a fabric softener active base; preferably chosen in the group consisting of dialkyl quaternary ammonium salts, dialkyl ester quaternary ammonium salts (esterquats), Hamburg esterquat (HEQ), TEAQ (triethanolamine quat), silicones and mixtures thereof, preferably in an amount comprised between 85 and 99.95% by weight based on the total weight of the composition;
free perfume; and
the delivery system as defined above, preferably in an amount comprised between 0.05 to 15 wt %, more preferably between 0.1 and 5 wt % by weight based on the total weight of the composition.

In a particular embodiment, the laundry composition is in form of a liquid detergent comprising:
a liquid detergent active base; preferably chosen in the group consisting of anionic surfactant such as alkylbenzenesulfonate (ABS), secondary alkyl sulfonate (SAS), primary alcohol sulfate (PAS), lauryl ether sulfate (LES), methyl ester sulfonate (MES) and nonionic surfactant such as alkyl amines, alkanolamide, fatty alcohol poly(ethylene glycol) ether, fatty alcohol ethoxylate (FAE), ethylene oxide (EO) and propylene oxide (PO) copolymers, amine oxydes, alkyl polyglucosides, alkyl polyglucosamides, preferably in an amount comprised between 85 and 99.95% by weight based on the total weight of the composition;
free perfume; and
the delivery system as defined above, preferably in an amount comprised between 0.05 to 15 wt %, more preferably between 0.1 and 5 wt % by weight based on the total weight of the composition.

In a particular embodiment, the laundry composition is in form of a solid detergent comprising:
a solid detergent active base; preferably chosen in the group consisting of anionic surfactant such as alkylbenzenesulfonate (ABS), secondary alkyl sulfonate (SAS), primary alcohol sulfate (PAS), lauryl ether sulfate (LES), methyl ester sulfonate (MES) and nonionic surfactant such as alkyl amines, alkanolamide, fatty alcohol poly(ethylene glycol) ether, fatty alcohol ethoxylate (FAE), ethylene oxide (EO) and propylene oxide (PO) copolymers, amine oxydes, alkyl polyglucosides, alkyl polyglucosamides, preferably in an amount comprised between 85 and 99.95% by weight based on the total weight of the composition;
free perfume;
the delivery system as defined above, preferably in an amount comprised between 0.05 to 15 wt %, more preferably between 0.1 and 5 wt % by weight based on the total weight of the composition.

### Solid Scent Booster

In a particular embodiment, the laundry composition is in form of a solid scent booster comprising:
a solid carrier, preferably chosen in the group consisting of urea, sodium chloride, sodium sulphate, sodium acetate, zeolite, sodium carbonate, sodium bicarbonate, clay, talc, calcium carbonate, magnesium sulfate, gypsum, calcium sulfate, magnesium oxide, zinc oxide, titanium dioxide, calcium chloride, potassium chloride, magnesium chloride, zinc chloride, saccharides such as sucrose, mono-, di-, and polysaccharides and derivatives such as starch, cellulose, methyl cellulose, ethyl cellulose, propyl cellulose, polyols/sugar alcohols such as sorbitol, maltitol, xylitol, erythritol, and isomalt, PEG, PVP, citric acid or any water soluble solid acid, fatty alcohols or fatty acids and mixtures thereof,
free perfume
the delivery system as defined above, in a powdered form, preferably in an amount comprised between 0.05 to 15 wt %, more preferably between 0.1 and 5 wt % by weight based on the total weight of the composition.

### Liquid Scent Booster

In a particular embodiment, the laundry composition is in form of a liquid scent booster comprising:
an aqueous phase,
a surfactant system essentially consisting of one or more than one non-ionic surfactant, wherein the surfactant system has a mean HLB between 10 and 14, preferably chosen in the group consisting of ethoxylated aliphatic alcohols, POE/PPG (polyoxyethylene and polyoxypropylene) ethers, mono and polyglyceryl esters, sucrose ester compounds, polyoxyethylene hydroxylesters, alkyl polyglucosides, amine oxides and combinations thereof;
   a linker chosen in the group consisting of alcohols, salts and esters of carboxylic acids, salts and esters of hydroxyl carboxylic acids, fatty acids, fatty acid salts, glycerol fatty acids, surfactant having an HLB less than 10 and mixtures thereof,
   free perfume
the delivery system as defined above, in the form of a slurry, preferably in an amount comprised between 0.05 to 15 wt %, more preferably between 0.1 and 5 wt % by weight based on the total weight of the composition.

According to an embodiment, the following fabric softener is excluded from the present invention.

TABLE 5
Fabric Softener composition

| Product | Wt % |
|---|---|
| Stepantex VL 90A | 8.88 |
| Calcium Chloride Sol. 10% | 0.36 |
| Proxel GXL | 0.04 |
| Perfume | 1 |
| Water | 89.72 |
| TOTAL | 100 |

The invention will now be further described by way of examples. It will be appreciated that the invention as claimed is not intended to be limited in any way by these examples

### EXAMPLES

### General Protocol for Preparing Microcapsules

### Protocol 1

Aqueous solutions of 10% wt. pork gelatine (A), and 10% wt. gum Arabic (B) are prepared separately.

The fragrance (Perfume A, B, C, D) to be encapsulated is mixed with a given amount of poly-isocyanate (trimethylol propane-adduct of xylylene diisocyanate, Takenate® D-110N, Mitsui Chemical) (C).

In a vessel at 40° C., the solution (A) and the solution (B) are added to warm demineralised water under mechanical shear. pH is adjusted to 4.45 using HCl 1M. The mixture is maintained at 40° C. during 15 min.

The solution (C) is slowly added to the mixture and emulsified/homogenised by mechanical shear forces (impeller, disperser, turbine etc. . . . ) at a given rate to reach the desired average droplet size. Mechanical shear is maintained at the same rate and the solution is then subjected to a thermal treatment at 50-90° C. After a duration between 30 to 240 min, the mixture is cooled down to 10° C. at a controlled rate between 0.2 and 0.3° C.·min⁻¹. The stirring speed is slightly decreased, and a cross-linking agent (glutaraldehyde aq.50% wt. Supplied by Sigma-Aldrich) is finally added to the mixture. The capsule suspension is mixed during 4 to 10 hours at 20-25° C. to allow a complete reaction.

The result is an aqueous suspension of microcapsules.

### Protocol 2

Aqueous solutions of 10% wt. pork gelatine (A), and 10% wt. gum Arabic (B) are prepared separately.

The fragrance (Perfume A, B, C, D) to be encapsulated is mixed with a given amount of poly-isocyanate (trimethylol propane-adduct of xylylene diisocyanate, Takenate® D-110N, Mitsui Chemical) (C).

In a vessel at 40° C., the solution (A) and the solution (B) are added to warm demineralised water under mechanical shear.

The solution (C) is slowly added to the mixture and emulsified/homogenised by mechanical shear forces (impeller, disperser, turbine etc. . . . ) at a given rate to reach the desired average droplet size. pH is adjusted to 4.45 using HCl 1M. The mixture is kept at 40° C. during 15 min. Mechanical shear is maintained at the same rate and the solution is then subjected to a thermal treatment at 50-90° C. After a duration between 30 to 240 min, the mixture is cooled down to 10° C. at a controlled rate between 0.2 and 0.3° C.·min⁻¹. The stirring speed is slightly decreased, and a cross-linking agent (glutaraldehyde aq.50% wt. Supplied by Sigma-Aldrich) is finally added to the mixture. The capsule suspension is mixed during 4 to 10 hours at 20-25° C. to allow a complete reaction.

The result is an aqueous suspension of microcapsules.

### Protocol 3

An aqueous solution of 10% wt. pork gelatine (A) is prepared separately.

A fragrance (Perfume A, B, C, D) to be encapsulated is mixed with poly-isocyanate (trimethylol propane-adduct of xylylene diisocyanate, Takenate® D-110N, Mitsui Chemical) (B).

Gum Arabic is dissolved in demineralised water to form the aqueous phase. The mixture is stirred until complete solubilisation and warmed at 40° C. Solution (B) is dispersed in the aqueous phase and emulsified by mechanical shear, static mixer, rotor-stator or rotor-rotor to obtain the desired particle size. Solution (A) is then added to the mixture under continued mechanical shear, the pH is adjusted to 4.45 using HCl 1M and maintained as such during 10 min.

Mechanical shear is maintained at the same rate and the solution is then subjected to a thermal treatment at 50-90° C. After a duration between 30 to 240 min, the mixture is cooled down to 10° C. at a controlled rate between 0.2 and 0.3° C.·min⁻¹. The stirring speed is slightly decreased, and a cross-linking agent (glutaraldehyde aq.50% wt. Supplied by Sigma-Aldrich) is finally added to the mixture. The capsule suspension is mixed during 4 to 10 hours at 20-25° C. to allow a complete reaction.

The result is an aqueous suspension or slurry of microcapsules.

Same protocol have also been carried out without adding the polyisocyanate.

TABLE 1
Perfume oil A

| | % in | | Log | | | | |
|---|---|---|---|---|---|---|---|
| Ingredient | formula | Log P | ODT | Group | δD | δP | δH |
| (+−)-ETHYL 2- | 2.2% | <3 | >−4 | | 12-20 | 1-8 | 2.5-11 |
| METHYLBUTANOATE | | | | | | | |
| 2-PHENYLETHYL ACETATE | 2.4% | <3 | >−4 | 3 | 12-20 | 1-8 | 2.5-11 |
| 1-METHOXY-4-METHYLBENZENE | 0.5% | <3 | >−4 | | 12-20 | 1-8 | 2.5-11 |
| HEXYL ACETATE | 11.70% | <3 | >−4 | | 12-20 | 1-8 | 2.5-11 |
| TRICYCLO[5.2.1,0~2,6~]DEC-3- | 28.5% | <3 | >−4 | 5 | 12-20 | 1-8 | 2.5-11 |
| EN-8-YL ACETATE (A) + | | | | | | | |
| TRICYCLO[5.2.1.0~2,6~]DEC-4- | | | | | | | |
| EN-8-YL ACETATE (B) | | | | | | | |
| (1 RS,2RS)-2,4-DIMETHYL-3- | 3.15% | <3 | >−4 | 1 | 12-20 | 1-8 | 2.5-11 |
| CYCLOHEXENE-1- | | | | | | | |
| CARBALDEHYDE (A) + (1 RS,2SR)- | | | | | | | |
| 2,4-DIMETHYL-3-CYCLOHEXENE- | | | | | | | |
| 1-CARBALDEHYDE (B) | | | | | | | |
| METHYL 2-((1RS,2RS)-3-OXO-2- | 1.0% | <3 | >−4 | 2 | 12-20 | 1-8 | 2.5-11 |
| PENTYLCYCLOPENTYL) ACETATE | | | | | | | |
| (+−)-2,6-DIMETHYL-5-HEPTENAL | 0.1% | 3-3.5 | >−4 | | 12-20 | 1-8 | 2.5-11 |
| (+−)-2,6-DIMETHYL-7-OCTEN-2-OL | 9.5% | 3-3.5 | >−4 | | 12-20 | 1-8 | 2.5-11 |
| 3,7-DIMETHYL-2,6-OCTADIEN-1- | 1.9% | 3-3.5 | >−4 | | 12-20 | 1-8 | 2.5-11 |
| OL | | | | | | | |
| (2RS,4SR)-4-METHYL-2-(2- | 0.75% | >3.5 | >−4 | 1 | 12-20 | 1-8 | 2.5-11 |
| METHYL-1-PROPEN-1- | | | | | | | |
| YL)TETRAHYDRO-2H-PYRAN (A) + | | | | | | | |
| (2RS,4RS)-4-METHYL-2-(2- | | | | | | | |
| METHYL-1-PROPEN-1- | | | | | | | |
| YL)TETRAHYDRO-2H-PYRAN (B) | | | | | | | |
| 3-(4,4-DIMETHYL-1- | 0.25% | >3.5 | >−4 | | 12-20 | 1-8 | 2.5-11 |
| CYCLOHEXEN-1-YL)PROPANAL | | | | | | | |
| 1,1′-OXYDIBENZENE | 2.35% | >3.5 | >−4 | 3 | >20 | 1-8 | 2.5-11 |
| (+−)-(E)-4-METHYL-3-DECEN-5-OL | 4.75% | >3.5 | >−4 | | 12-20 | 1-8 | 2.5-11 |
| (2E)-1-[(1RS,2SR)-2,6,6- | 1.45% | >3.5 | <−4 | 3 | 12-20 | 1-8 | 2.5-11 |
| TRIMETHYL-3-CYCLOHEXEN-1- | | | | | | | |
| YL]-2-BUTEN-1-ONE | | | | | | | |
| (+−)-1,5-DIMETHYL-1-VINYL-4- | 2.85% | >3.5 | >−4 | | 12-20 | 1-8 | 2.5-11 |
| HEXENYL ACETATE | | | | | | | |
| (3E)-4-(2,6,6-TRIMETHYL-1- | 0.40% | >3.5 | <−4 | 3 | 12-20 | 1-8 | 2.5-11 |
| CYCLOHEXEN-1-YL)-3-BUTEN-2- | | | | | | | |
| ONE | | | | | | | |
| 2-METHYLBUTYL SALICYLATE (A) | 3.80% | >3.5 | >−4 | 3 | 12-20 | 1-8 | 2.5-11 |
| + PENTYL SALICYLATE (B) | | | | | | | |
| (+−)-2-METHYLUNDECANAL | 13.90% | >3.5 | <−4 | | 12-20 | 1-8 | 2.5-11 |
| HEXYL 2-HYDROXYBENZOATE | 8.55% | >3.5 | >−4 | 3 | 12-20 | 1-8 | 2.5-11 |
| Total | 100% | | | | | | |

| | |
|---|---|
| Log P > 3 * | 50.6% |
| Log P > 3.5 * | 39.1% |
| Log T <− 4 * | 15.8% |
| Group 1-6 * | 52.4% |
| Group 3-6 * | 47.5% |
| HSP | 100% |

* excluding hydrophobic solvent

TABLE 2
Variations of Perfume oil A with more hydrophobic and density
adjuster solvents

| Perfume | A | A1 | A2 |
|---|---|---|---|
| Parts Perfume A | 97% | 70% | 50% |
| METHYL | 3% | 15% | 25% |
| DIHYDROABIETATE (A) | | | |
| + METHYL ABIETATE (B) | | | |
| + METHYL | | | |
| DEHYDROABIETATE (C) | | | |
| + METHYL | | | |
| TETRAHYDROABIETATE (D) | | | |
| CYCLOHEXYL SALICYLATE | 0% | 15% | 25% |

TABLE 3
Perfume oil B

| | % in | | Log | | | | |
|---|---|---|---|---|---|---|---|
| Ingredient | formula | Log P | ODT | Group | δD | δP | δH |
| (Z)-3-HEXEN-1-OL | 0.20% | <3 | >−4 | | 12-20 | 1-8 | >11 |
| (2-METHOXYETHYL)BENZENE | 1.40% | <3 | >−4 | | 12-20 | 1-8 | 2.5-11 |
| TRICYCLO[5.2.1.0~2,6~]DEC-3-EN-8-YL | 30.00% | <3 | >−4 | 5 | 12-20 | 1-8 | 2.5-11 |
| ACETATE (A) + TRICYCLO[5.2.1.0~2,6~]DEC-4- | | | | | | | |
| EN-8-YL ACETATE (B) | | | | | | | |
| (+−)-2,6-DIMETHYL-5-HEPTENAL | 0.75% | 3-3.5 | >−4 | | 12-20 | 1-8 | 2.5-11 |
| 1,3,3-TRIMETHYL-2- | 3.20% | 3-3.5 | >−4 | 5 | 12-20 | 1-8 | 2.5-11 |
| OXABICYCLO[2.2.2]OCTANE | | | | | | | |
| (+−)-4-METHYLENE-2-PHENYLTETRAHYDRO- | 1.30% | 3-3.5 | <−4 | 3 | 12-20 | 1-8 | 2.5-11 |
| 2H-PYRAN (A) + (+−)-4-METHYL-6-PHENYL-3,6- | | | | | | | |
| DIHYDR0-2H-PYRAN (B) + (+−)-4-METHYL-2- | | | | | | | |
| PHENYL-3,6-DIHYDRO-2H-PYRAN (C) | | | | | | | |
| .ALPHA.-DIHYDROTERPINEOL (A) + .BETA.- | 9.45% | 3-3.5 | >−4 | 1 | 12-20 | 1-8 | 2.5-11 |
| DIHYDROTERPINEOL (B) | | | | | | | |
| (2RS,4SR)-4-METHYL-2-(2-METHYL-1- | 5.50% | >3.5 | >−4 | 1 | 12-20 | 1-8 | 2.5-11 |
| PROPEN-1-YL)TETRAHYDRO-2H-PYRAN (A) + | | | | | | | |
| (2RS,4RS)-4-METHYL-2-(2-METHYL-1- | | | | | | | |
| PROPEN-1-YL)TETRAHYDRO-2H-PYRAN (B) | | | | | | | |
| (+−)-3,7-DIMETHYL-1-OCTANOL | 0.20% | >3.5 | >−4 | | 12-20 | 1-8 | 2.5-11 |
| 2-UNDECANONE | 5.50% | >3.5 | >−4 | | 12-20 | 1-8 | 2.5-11 |
| 2-METHOXY-3-(4-METHYLPENTYL)PYRAZINE | 0.10% | >3.5 | <−4 | | 12-20 | 1-8 | 2.5-11 |
| (+−)-3-(3-ISOPROPYL-1-PHENYL)BUTANAL | 1.30% | >3.5 | <−4 | 3 | 12-20 | 1-8 | 2.5-11 |
| 3-(4-ETHYLPHENYL)-2,2- | 2.85% | >3.5 | >−4 | 3 | 12-20 | 1-8 | 2.5-11 |
| DIMETHYLPROPANAL (A) + 3-(2- | | | | | | | |
| ETHYLPHENYL)-2,2-DIMETHYLPROPANAL (B) | | | | | | | |
| 10-UNDECENAL (A) + (9E)-9-UNDECENAL (B) + | 2.85% | >3.5 | <−4 | | 12-20 | 1-8 | 2.5-11 |
| (9Z)-9-UNDECENAL (C) | | | | | | | |
| (+−)-(E)-4-METHYL-3-DECEN-5-OL | 13.60% | >3.5 | >−4 | | 12-20 | 1-8 | 2.5-11 |
| (2E)-1-[(1RS,2SR)-2,6,6-TRIMETHYL-3- | 0.60% | >3.5 | <−4 | 3 | 12-20 | 1-8 | 2.5-11 |
| CYCLOHEXEN-1-YL]-2-BUTEN-1-ONE | | | | | | | |
| 8-ISOPROPYL-6-METHYL-BICYCLO[2.2.2]OCT- | 0.10% | >3.5 | <−4 | 5 | 12-20 | 1-8 | 2.5-11 |
| 5-ENE-2-CARBALDEHYDE | | | | | | | |
| 1-(5,5-DIMETHYL-1-CYCLOHEXEN-1-YL)-4- | 1.30% | >3.5 | <−4 | 3 | 12-20 | 1-8 | 2.5-11 |
| PENTEN-1-ONE | | | | | | | |
| (+−)-2-METHYLUNDECANAL | 13.60% | >3.5 | <−4 | | 12-20 | 1-8 | 2.5-11 |
| (+−)-2-(4-METHYL-3-CYCLOHEXEN-1-YL)-2- | 0.10% | >3.5 | <−4 | 1 | 12-20 | 1-8 | 2.5-11 |
| PROPANETHIOL | | | | | | | |
| (−)-(3AR,5AS,9AS,9BR)-3A,6,6,9A- | 0.60% | >3.5 | <−4 | 4 | 12-20 | 1-8 | 2.5-11 |
| TETRAMETHYLDODECAHYDRONAPHTHO[2,1- | | | | | | | |
| B]FURAN | | | | | | | |
| (2Z)-1,1-DIETHOXY-3,7-DIMETHYL-2,6- | 4.05% | >3.5 | >−4 | | 12-20 | 1-8 | 2.5-11 |
| OCTADIENE (A) + (2E)-1,1-DIETHOXY-3,7- | | | | | | | |
| DIMETHYL-2,6-OCTADIENE (B) | | | | | | | |
| CLEARWOOD ® | 1.45% | >3.5 | <−4 | 5 | 12-20 | 1-8 | 2.5-11 |
| TOTAL | 100% | | | | | | |

| | |
|---|---|
| Log P > 3: | 68.4% |
| Log P > 3.5 | 53.7% |
| Log T <− 4 | 23.3% |
| Group 1-6 | 57.8% |
| Group 3-6 | 42.7% |
| HSP | 100% |

TABLE 4
Variations of Perfume oil B with more hydrophobic and density
adjuster solvent

| Perfume | B | B1 | B2 |
|---|---|---|---|
| Parts Perfume B | 100% | 75% | 50% |
| Phenylethyl Phenylacetate | 0% | 2.5% | 5% |
| Cyclohexyl salicylate | 0% | 22.5% | 45% |

TABLE 5
Perfume oil C

| | % in | | Log | | | | |
|---|---|---|---|---|---|---|---|
| Ingredient | formula | Log P | ODT | Group | δD | δP | δH |
| (Z)-3-HEXENYL ACETATE | 1.15% | <3 | >−4 | | 12-20 | 1-8 | 2.5-11 |
| (1 RS,2RS)-2,4-DIMETHYL-3- | 5.70% | <3 | >−4 | 1 | 12-20 | 1-8 | 2.5-11 |
| CYCLOHEXENE-1- | | | | | | | |
| CARBALDEHYDE (A) + (1 RS,2SR)- | | | | | | | |
| 2,4-DIMETHYL-3-CYCLOHEXENE- | | | | | | | |
| 1-CARBALDEHYDE (B) | | | | | | | |
| METHYL 2-((1 RS,2RS)-3-OXO-2- | 2.60% | <3 | >−4 | 2 | 12-20 | 1-8 | 2.5-11 |
| PENTYLCYCLOPENTYL) ACETATE | | | | | | | |
| (+−)-5-HEPTYLDIHYDRO-2(3H)- | 8.00% | 3-3.5 | <−4 | | 12-20 | 1-8 | 2.5-11 |
| FURANONE | | | | | | | |
| 1,3,3-TRIMETHYL-2- | 6.10% | 3-3.5 | >−4 | 5 | 12-20 | 1-8 | 2.5-11 |
| OXABICYCLO[2.2.2]OCTANE | | | | | | | |
| 2-METHOXYNAPHTHALENE | 8.00% | 3-3.5 | <−4 | 4 | >20 | 1-8 | 2.5-11 |
| 3,5,6-TRIMETHYL-3- | 1.05% | 3-3.5 | >−4 | 1 | 12-20 | 1-8 | 2.5-11 |
| CYCLOHEXENE-1- | | | | | | | |
| CARBALDEHYDE (A) + 2,4,6- | | | | | | | |
| TRIMETHYL-3-CYCLOHEXENE-1- | | | | | | | |
| CARBALDEHYDE (B) | | | | | | | |
| (Z)-3-HEXENYL ISOBUTYRATE | 0.65% | >3.5 | >−4 | | 12-20 | 1-8 | 2.5-11 |
| 3,7-DIMETHYL-2,6- | 12.40% | >3.5 | >−4 | | 12-20 | 1-8 | 2.5-11 |
| NONADIENENITRILE (A) + 3,7- | | | | | | | |
| DIMETHYL-3,6- | | | | | | | |
| NONADIENENITRILE (B) | | | | | | | |
| (1R,2R)-1,7,7-TRIMETHYL- | 12.75% | >3.5 | >−4 | 5 | 12-20 | 1-8 | 2.5-11 |
| BICYCLO[2.2.1]HEPT-2-YL | | | | | | | |
| ACETATE | | | | | | | |
| 10-UNDECENAL (A) + (9E)-9- | 1.35% | >3.5 | <−4 | | 12-20 | 1-8 | 2.5-11 |
| UNDECENAL (B) + (9Z)-9- | | | | | | | |
| UNDECENAL (C) | | | | | | | |
| (−)-(1S)-2,6,6-TRIMETHYL- | 3.25% | >3.5 | >−4 | | 12-20 | <1 | 2.5-11 |
| BICYCLO[3.1.1]HEPT-2-ENE | | | | | | | |
| (+−)-1,5-DIMETHYL-1-VINYL-4- | 12.40% | >3.5 | >−4 | | 12-20 | 1-8 | 2.5-11 |
| HEXENYL ACETATE | | | | | | | |
| 1-(5,5-DIMETHYL-1- | 1.60% | >3.5 | <−4 | 3 | 12-20 | 1-8 | 2.5-11 |
| CYCLOHEXEN-1-YL)-4-PENTEN-1- | | | | | | | |
| ONE | | | | | | | |
| 3,7-DIMETHYL-6-OCTENYL | 4.75% | >3.5 | >−4 | | 12-20 | 1-8 | 2.5-11 |
| ACETATE | | | | | | | |
| (+−)-2-METHYLUNDECANAL | 8.00% | >3.5 | <−4 | | 12-20 | 1-8 | 2.5-11 |
| (+−)-2-(4-METHYL-3- | 0.10% | >3.5 | <−4 | 1 | 12-20 | 1-8 | 2.5-11 |
| CYCLOHEXEN-1-YL)-2- | | | | | | | |
| PROPANETHIOL | | | | | | | |
| (+−)-(3E)-3-METHYL-4-(2,6,6- | 0.65% | >3.5 | <−4 | 3 | 12-20 | 1-8 | 2.5-11 |
| TRIMETHYL-2-CYCLOHEXEN-1- | | | | | | | |
| YL)-3-BUTEN-2-ONE (A) + (+−)- | | | | | | | |
| (1E)-1-(2,6,6-TRIMETHYL-2- | | | | | | | |
| CYCLOHEXEN-1-YL)-1-PENTEN-3- | | | | | | | |
| ONE (B) | | | | | | | |
| 1-OXA-12-CYCLOHEXADECEN-2- | 4.75% | >3.5 | >−4 | 6 | 12-20 | 1-8 | 2.5-11 |
| ONE (A) + 1-OXA-13- | | | | | | | |
| CYCLOHEXADECEN-2-ONE (B) | | | | | | | |
| OXACYCLOHEXADECAN-2-ONE | 4.75% | >3.5 | >−4 | 6 | 12-20 | 1-8 | 2.5-11 |
| TOTAL | 100.00% | | | | | | |

| | |
|---|---|
| Log P > 3: | 90.6% |
| Log P > 3.5 | 67.4% |
| Log T <− 4 | 28.6% |
| Group 1-6 | 49.7% |
| Group 3-6 | 39.9% |
| HSP | 100% |

TABLE 6
Variations of Perfume oil C with more hydrophobic and density
adjuster solvent

| Perfume | C | C1 | C2 |
|---|---|---|---|
| Parts Perfume C | 100% | 80% | 55% |
| Benzyl salicylate | 0% | 20% | 45% |

TABLE 7
Perfume oil D

| | % in | | Log | | | | |
|---|---|---|---|---|---|---|---|
| Ingredient | formula | Log P | ODT | Group | δD | δP | δH |
| OCTANAL | 2.50% | <3 | >−4 | | 12-20 | 1-8 | 2.5-11 |
| 1,3,3-TRIMETHYL-2- | 2.10% | 3-3.5 | >−4 | 5 | 12-20 | 1-8 | 2.5-11 |
| OXABICYCLO[2.2.2]OCTANE | | | | | | | |
| 2-METHOXYNAPHTHALENE | 10.00% | 3-3.5 | <−4 | 4 | >20 | 1-8 | 2.5-11 |
| (+−)-4-METHYLENE-2-PHENYLTETRAHYDRO- | 3.00% | 3-3.5 | <−4 | 3 | 12-20 | 1-8 | 2.5-11 |
| 2H-PYRAN (A) + (+−)-4-METHYL-6-PHENYL-3,6- | | | | | | | |
| DIHYDRO-2H-PYRAN (B) + (+−)-4-METHYL-2- | | | | | | | |
| PHENYL-3,6-DIHYDRO-2H-PYRAN (C) | | | | | | | |
| DECANAL | 5.00% | >3.5 | >−4 | | 12-20 | 1-8 | 2.5-11 |
| (+−)-3,7-DIMETHYL-6-OCTENAL | 30.00% | >3.5 | >−4 | | 12-20 | 1-8 | 2.5-11 |
| (+)-(3S)-3-[(1R)-4-METHYL-3-CYCLOHEXEN-1- | 10.00% | >3.5 | >−4 | 3 | 12-20 | 1-8 | 2.5-11 |
| YL]BUTANAL (A) + (+)-(3R)-3-[(1R)-4-METHYL- | | | | | | | |
| 3-CYCLOHEXEN-1-YL]BUTANAL | | | | | | | |
| (1 R,2R)-1,7,7-TRIMETHYL- | 5.00% | >3.5 | >−4 | 5 | 12-20 | 1-8 | 2.5-11 |
| BICYCLO[2.2.1]HEPT-2-YL ACETATE | | | | | | | |
| 8-ISOPROPYL-6-METHYL-BICYCLO[2.2.2]OCT- | 0.60% | >3.5 | <−4 | 5 | 12-20 | 1-8 | 2.5-11 |
| 5-ENE-2-CARBALDEHYDE | | | | | | | |
| (+−)-2-METHYLUNDECANAL | 8.00% | >3.5 | <−4 | | 12-20 | 1-8 | 2.5-11 |
| (−)-(3AR,5AS,9AS,9BR)-3A,6,6,9A- | 0.70% | >3.5 | <−4 | 4 | 12-20 | 1-8 | 2.5-11 |
| TETRAMETHYLDODECAHYDRONAPHTHO[2,1- | | | | | | | |
| B]FURAN | | | | | | | |
| (2Z)-1,1-DIETHOXY-3,7-DIMETHYL-2,6- | 20.00% | >3.5 | >−4 | | 12-20 | 1-8 | 2.5-11 |
| OCTADIENE (A) + (2E)-1,1-DIETHOXY-3,7- | | | | | | | |
| DIMETHYL-2,6-OCTADIENE (B) | | | | | | | |
| (2Z)-2-TRIDECENENITRILE (A) + (3Z)-3- | 2.00% | >3.5 | <−4 | | 12-20 | 1-8 | 2.5-11 |
| TRIDECENENITRILE (B) + (3E)-3- | | | | | | | |
| TRIDECENENITRILE (C) + (2E)-2- | | | | | | | |
| TRIDECENENITRILE (D) | | | | | | | |
| PATCHOULI OIL | 1.10% | >3.5 | <−4 | 5 | 12-20 | 1-8 | 2.5-11 |
| TOTAL | 100% | | | | | | |

| | |
|---|---|
| Log P > 3: | 97.5% |
| Log P > 3.5 | 82.4% |
| Log T <− 4 | 25.4% |
| Group 1-6 | 32.5% |
| Group 3-6 | 32.5% |
| HSP | 100% |

TABLE 8
Variations of Perfume oil D with more hydrophobic & density
adjuster solvent

| Perfume | D | D1 | D2 |
|---|---|---|---|
| Parts Perfume D | 100% | 75% | 50% |
| Phenylethyl Phenylacetate | 0% | 2.5% | 5% |
| Cyclohexyl salicylate | 0% | 22.5% | 45% |

### Example 1

### Preparation of Microcapsules Slurry

Microcapsules A-D have been prepared by using Protocol 3. Similar results have been obtained by using Protocol 1 and 2.

TABLE 9
Microcapsules compositions

| Components | A | B | C | D |
|---|---|---|---|---|
| Water | 74.8 | 74.8 | 74.8 | 74.8 |
| Gum arabic¹⁾ | 1.1 | 1.1 | 1.1 | 1.1 |
| Gelatine²⁾ | 1.1 | 1.1 | 1.1 | 1.1 |
| Perfume³⁾ | 22.1 | 22.1 | 22.1 | 22.1 |
| | (Perfume A) | (Perfume B) | (Perfume C) | (Perfume D) |
| Takenate ®⁴⁾ | 0.40 | 0.40 | 0.40 | 0.40 |
| Lactic acid⁵⁾ | 0.5 | 0.5 | 0.5 | 0.5 |
| Glutaraldehyde⁶⁾ | 0.04 | 0.04 | 0.04 | 0.04 |
| Particle size (microns) | 72 | 72 | 72 | 72 |
| Weight ratio in the slurry | 88:12 | 88:12 | 88:12 | 88:12 |
| between coacervate and | | | | |
| polyisocyanate | | | | |
| Weight concentration of | 0.30% | 0.30% | 0.30% | 0.30% |
| the polyisocyanate in the | | | | |
| slurry | | | | |

¹⁾Nexira
²⁾PB Leiner
³⁾See tables 1, 3, 5 & 7
⁴⁾Trimethylol propane-adduct of xylylene diisocyanate, origin: Mitsui Chemicals, Inc., Japan, 75% solution of polyisocyanate in ethyl acetate
⁵⁾Purac Biochem, 90% aqueous solution
⁶⁾Sigma Aldrich, 50% aqueous solution

Some of the microcapsules slurries (A, B, C and D) were mixed then with preservatives and thickening polymers (0.5% sodium benzoate and 0.1 to 0.5% xanthan gum).

### Example 2

### Stability Performance in a Fabric Softener Composition

Capsules of the present invention were dispersed in fabric softener base described in table 9 to obtain a concentration of encapsulated perfume oil at 0.22% and stability was evaluated after 1 month at the elevated temperature of 37° C.

TABLE 10
Fabric Softener composition

| Product | Wt % |
|---|---|
| Stepantex VL 90A | 8.88 |
| Calcium Chloride Sol. 10% | 0.36 |
| Proxel GXL | 0.04 |
| Perfume 1) | 1 |
| Water | 89.72 |
| TOTAL | 100 |

1) See table A

| | % |
|---|---|
| DIPROPYLENE GLYCOL | 35.00% |
| 2-ETHYL-3-HYDROXY-4(4H)- | 1.50% |
| PYRANONE | |
| VANILLIN PERF | 1.50% |
| 4-(4-METHOXYPHENYL)-2- | 2.90% |
| BUTANONE | |
| ETHYL VANILLIN | 3.60% |
| BENZO[D][1,3]DIOXOLE-5- | 1.10% |
| CARBALDEHYDE | |
| ANISALDEHYDE SPECIAL REDIST | 0.25% |
| (+−)-1-PHENYLETHYL ACETATE | 0.90% |
| (Z)-3-HEXEN-1-OL ACETATE | 0.35% |
| 2-METHOXY-4-(2-PROPEN-1- | 1.40% |
| YL)PHENOL | |
| (+−)-ETHYL 2- | 3.00% |
| METHYLPENTANOATE | |
| (1RS,2RS)-2,4-DIMETHYL-3- | 0.60% |
| CYCLOHEXENE-1- | |
| CARBALDEHYDE (A) + (1RS,2SR)- | |
| 2,4-DIMETHYL-3-CYCLOHEXENE- | |
| 1-CARBALDEHYDE (B) | |
| MENTHONE PURIFIED | 0.10% |
| METHYLISOEUGENOL | 0.75% |
| METHYL 2-((1RS,2RS)-3-OXO-2- | 3.80% |
| PENTYLCYCLOPENTYL)ACETATE | |
| ETHYL | 1.00% |
| METHYLPHENYLGLYCIDATE | |
| UNDECALACTONE GAMMA | 4.25% |
| DIETHYL CIS-1,4- | 1.50% |
| CYCLOHEXANEDICARBOXYLATE | |
| (A) + DIETHYL TRANS-1,4- | |
| CYCLOHEXANEDICARBOXYLATE | |
| (B) | |
| METHYL 2,4-DIHYDROXY-3,6- | 0.35% |
| DIMETHYLBENZOATE | |
| (2Z)-2-PHENYL-2- | 0.80% |
| HEXENENITRILE | |
| BENZYLDIMETHYLCARBINOL | 2.90% |
| ACETATE | |
| PHENYLHEXANOL | 2.20% |
| CITRONELLOL BJ | 3.55% |
| (2RS,4SR)-4-METHYL-2-(2- | 0.40% |
| METHYL-1-PROPEN-1- | |
| YL)TETRAHYDRO-2H-PYRAN | |
| (A) + (2RS,4RS)-4-METHYL-2-(2- | |
| METHYL-1-PROPEN-1- | |
| YL)TETRAHYDRO-2H-PYRAN (B) | |
| (+−)-3,7-DIMETHYL-3-OCTANOL | 4.00% |
| 9-DECEN-1-OL | 0.40% |
| (+−)-2,2,2-TRICHLORO-1- | 1.40% |
| PHENYLETHYL ACETATE | |
| (4E)-4-METHYL-5-(4- | 0.10% |
| METHYLPHENYL)-4-PENTENAL | |
| DIPHENYLOXIDE | 0.70% |
| (+−)-(2E)-1-(2,6,6-TRIMETHYL-2- | 0.25% |
| CYCLOHEXEN-1-YL)-2-BUTEN-1- | |
| ONE | |
| BENZYL SALICYLATE | 2.20% |
| 3-(3,3-DIMETHYL-2,3-DIHYDRO- | 0.25% |
| 1H-INDEN-5-YL)PROPANAL (A) + | |
| 3-(1,1-DIMETHYL-2,3-DIHYDRO- | |
| 1H-INDEN-4-YL)PROPANAL (B) + | |
| 3-(1,1-DIMETHYL-2,3-DIHYDRO- | |
| 1H-INDEN-5-YL)PROPANAL (C) | |
| (+−)-(3E)-4-(2,6,6-TRIMETHYL-2- | 4.00% |
| CYCLOHEXEN-1-YL)-3-BUTEN-2- | |
| ONE (A) + (3E)-4-(2,6,6- | |
| TRIMETHYL-1-CYCLOHEXEN-1- | |
| YL)-3-BUTEN-2-ONE (B) | |
| GERANYL ACETATE EXTRA | 1.40% |
| (+−)-1-(OCTAHYDRO-2,3,8,8- | 3.70% |
| TETRAME-2-NAPHTHALENYL)-1- | |
| ETHANONE (DOUBLE BOND: 4A,5 | |
| (A) + 4,4A (B) + 4A,8A (C) | |
| DODECAHYDRO-3A,6,6,9A- | 0.40% |
| TETRAMETHYL-NAPHTHO[2,1- | |
| B]FURAN | |
| (Z)-3-HEXEN-1-OL SALICYLATE | 0.80% |
| 1-OXA-12-CYCLOHEXADECEN-2- | 0.25% |
| ONE (A) + 1-OXA-13- | |
| CYCLOHEXADECEN-2-ONE (B) | |
| HEXYL SALICYLATE | 3.55% |
| (−)-(2E)-2-ETHYL-4-[(1R)-2,2,3- | 2.20% |
| TRIMETHYL-3-CYCLOPENTEN-1- | |
| YL]-2-BUTEN-1-OL | |
| (+−)-1-(2,2,6-TRIMETHYL-1- | 0.70% |
| CYCLOHEXYLOXY)-2-PENTANOL | |
| | 100.00% |

### Protocol for the Stability Assessment

Weigh 1 g of sample into a 20 mL scintillation vial. Add 4 mL of water and mix for 5 min at 480 rpm on an IKA KS130 orbital shaker. Add 5 mL of extraction solvent (90% isooctane/10% ether with 150 ppm 1,4-dibromobenzene) and mix for 15 min at 480 rpm on an IKA KS130 orbital shaker. Transfer to a 15 mL centrifuge tube and spin for 60 min at 6000 rcf. Analyze the supernatant with a Shimatzu GCMS (model) or equivalent. All samples are compared to a free oil reference control which corresponds to 100% leakage.

TABLE 11
Results from the stability assessment

| % Perfume Leakage after | | | | |
|---|---|---|---|---|
| storage in softener | Capsule A | Capsule B | Capsule C | Capsule D |
| 15 days at 37° C. | 33% | 28% | 31% | 24% |
| 1 Month at 37° C. | 43% | 37% | 40% | 32% |
| 15 days at 43° C. | 43% | 36% | 38% | 30% |
| 1 Month at 43° C. | 55% | 47% | 50% | 39% |

One can conclude from Table 11, all capsules exhibit reasonable perfume leakage upon extended storage in fabric-softener, even at very elevated temperature like 43° C.

### Example 4

### Liquid Detergent Composition

A sufficient amount of microcapsule slurry A-D of the present invention was dispersed in liquid detergent base described in table 11 to obtain a concentration of encapsulated perfume oil at 0.22%.

TABLE 12
Composition of the liquid detergent formulation

| Ingredients | Concentration [wt %] |
|---|---|
| Sodium C14-17 Alkyl Sec Sulfonate¹⁾ | 7 |
| Fatty acids, C12-18 and C18-unsaturated²⁾ | 7.5 |
| C12/14 fatty alcohol polyglycol ether with | 17 |
| 7 mol EO³⁾ | |
| Triethanolamine | 7.5 |
| Propylene Glycol | 11 |
| Citric acid | 6.5 |
| Potassium Hydroxyde | 9.5 |
| Protease | 0.2 |
| Amylase | 0.2 |
| Mannanase | 0.2 |
| Acrylates/Steareth-20 Methacrylate | 6 |
| structuring Crosspolymer⁴⁾ | |
| Free perfume (see table A) | 0.75 |
| Deionized Water | 27.4 |

¹⁾Hostapur SAS 60; Origin: Clariant
²⁾Edenor K 12-18; Origin: Cognis
³⁾Genapol LA 070; Origin: Clariant
⁴⁾Aculyn 88; Origin: Dow Chemical

### Example 5

### Spray-Dried Microcapsules Preparation

Emulsions 1-5 having the following ingredients are prepared.

TABLE 13
Composition of Emulsion 1-5 and composition of granulated powder 1-5 after spray-drying

| Ingredients | Emulsion 1 | Emulsion 2 | Emulsion 3 | Emulsion 4 | Emulsion 5 |
|---|---|---|---|---|---|
| Modified starch ¹⁾ | 2.6% | 2.6% | 2.6% | 12.5% | 2% |
| Maltodextrin ²⁾ | 26.8% | 22.8% | 19.3% | 0% | 19.1% |
| Maltose ³⁾ | 0% | 0% | 0% | 7.9% | 0% |
| Citric Acid | 0% | 0% | 0% | 1% | 0% |
| Tripotassium | 0% | 0% | 0% | 1.9% | 0% |
| Citrate | | | | | |
| Microcapsules | 12.0% | 24% | 37.0% | 8.9% | 56.2% |
| A-D | | | | | |
| Silica ⁴⁾ | 1.1% | 1.1% | 1.1% | 0% | 0% |
| Free Perfume | 0% | 0% | 0% | 11% | 0% |
| Water | 57.6% | 49.6% | 40.1% | 56.9% | 22.7% |
| | Granule 1 | Granule 2 | Granule 3 | Granule 4 | Granule 5 |
| Modified starch ¹⁾ | 7.5% | 7.4% | 7.2% | 31.6% | 4.9% |
| Maltodextrin ²⁾ | 77.4% | 65.5% | 53.8% | 0% | 44.7% |
| Maltose | 0% | 0% | 0% | 20.9% | |
| Citric Acid | 0% | 0% | 0% | 2.6% | 0% |
| Tripotassium | 0% | 0% | 0% | 4.9% | 0% |
| citrate | | | | | |
| Encapsulated | 0% | 0% | 0% | 28.1% | 0% |
| perfume | | | | | |
| Microcapsules | 12.% | 24.1% | 36.1% | 9.8% | 48.4% |
| A-D | | | | | |
| Silica | 3.0 | 3.0% | 2.9% | 2.0% | 2% |
| Fragrance loading | 10.1% | 20.1% | 30% | 35.8% | 40.2% |
| in powder after | | | | | |
| spray-drying | | | | | |

¹⁾ CapsulTM, Ingredion
²⁾ Maltodextrin 10DE origin: Roquette
³⁾ Maltose, Lehmann & Voss
⁴⁾ Silica, Evonik

Components for the polymeric matrix (Maltodextrin and Capsul™, or Capsul™, citric acid and tripotassium citrate) are added in water at 45-50° C. until complete dissolution. For emulsion 4, free perfume C is added to the aqueous phase.

Microcapsules slurry is added to the obtained mixture. Then, the resulting mixture is then mixed gently at 25° C. (room temperature).

Granulated powder 1-5 are prepared by spray-drying Emulsion A-E using a Sodeva Spray Dryer (Origin France), with an air inlet temperature set to 215° C. and a throughput set to 500 ml per hour. The air outlet temperature is of 105° C. The emulsion before atomization is at ambient temperature.

### Example 6

### Liquid Scent Booster Composition

A sufficient amount of microcapsule slurry A-D is weighed and mixed in a liquid scent booster to add the equivalent of 0.2% perfume.

TABLE 14
Liquid scent booster composition

| | Amount (% wt) | | | | | |
|---|---|---|---|---|---|---|
| Ingredients | 1 | 2 | 3 | 4 | 5 | 6 |
| Water | 71.20% | 89.5% | 78.8% | 79.4% | 70% | 70% |
| Propylene glycol | 20.30% | — | — | — | 20% | 20% |
| Polyethylene | 4.00% | 6% | | | | |
| glycol | | | | | | |
| ethers of decyl | | | | | | |
| alcohol¹⁾ | | | | | | |
| Polyethylene | | | | | 4.00% | 4.00% |
| glycol | | | | | | |
| ether of Lauryl | | | | | | |
| Alcohol²⁾ | | | | | | |
| alkyl | | | 8.30% | 7.7% | | |
| polyglucoside | | | | | | |
| C8-C10³⁾ | | | | | | |
| Deceth-3¹⁾ | 1.50% | | | | | |
| Lauryl lactate | | | | 1% | | |
| Lauric acid | | 1.5% | 1.60% | | | |
| Glyceryl | | | | | 3.00% | 3.00% |
| Caprylate | | | | | | |
| Fragrance (see | 3.00% | 3.0% | 3.00% | 3.00% | 3.00% | 0% |
| table A) | | | | | | |

¹⁾Deceth-8; trademark and origin: KLK Oleo
²⁾Laureth-9;; trademark and origin
³⁾Plantacare 2000UP; trademark and origin: BASF

Different ringing gel compositions are prepared (compositions 1-6) according to the following protocol.

In a first step, the aqueous phase (water), the solvent (propylene glycol) if present and surfactants are mixed together at room temperature under agitation with magnetic stirrer at 300 rpm for 5 min.

In a second step, the linker is dissolved in the hydrophobic active ingredient (fragrance) at room temperature under agitation with magnetic stirrer at 300 rpm. The resulting mixture is mixed for 5 min.

Then, the aqueous phase and the oil phase are mixed together at room temperature for 5 min leading to the formation of a transparent or opalescent ringing gel.

### Example 7

### Powder Detergent Composition

A sufficient amount of granules 1-5 is weighed and mixed in a powder detergent composition to add the equivalent of 0.2% perfume.

TABLE 15
Powder detergent composition

| Ingredients | Part |
|---|---|
| Anionic (Linear Alkyl Benzene | 20% |
| Sulphonates) | |
| Nonionics (Alcohol Ethoxylates (5-9 | 6% |
| ethylene oxide) | |
| Builders (zeolites, sodium carbonate) | 25% |
| Silicates | 6% |
| Sodium Sulphate | 35% |
| Others (Enzymes, Polymers, Bleach) | 7.5% |
| Spray-dried granule powder 1-5 | 0.5% |

### Example 8

### Concentrated all Purpose Cleaner Composition

A sufficient amount of microcapsule slurry A-D is weighed and mixed in a concentrated all-purpose cleaner composition to add the equivalent of 0.2% perfume.

TABLE 16
concentrated all-purpose cleaner composition

| Ingredients | Amount (% wt) | Function |
|---|---|---|
| Ethoxylated Alcohol (C9-C11, | 20 | Non-ionic surfactant |
| 8EO) ⁽¹⁾ | | |
| Sodium Dodecyl Benzene | 16 | Anionic surfactant |
| Sulfonate ⁽²⁾ | | |
| Sodium Cumene Sulfonate ⁽³⁾ | 8 | Hydrotrope |
| Methyl chloro isothiazolinone | 0.8% | preservative |
| Methyl isothiazolinone 3.3:1 ⁽⁴⁾ | | |
| Water | 55.9 | solvent |

(1) Neodol 91-8 ®; trademark and origin: Shell Chemical
(2) Biosoft D-40 ®; trademark and origin: Stepan Company
(3) Stepanate SCS ®; trademark and origin: Stepan Company
(4) Kathon CG ®; trademark and origin: Dow Chemical Company
All ingredients are mixed together and then the mixture was diluted with water to 100%.

### Example 9

### Solid Scent Booster Composition

A sufficient amount of microcapsules in dried form is weighed and mixed with a solid scent booster composition to add the equivalent of 0.2% perfume.

TABLE 17
Salt-based solid scent booster compositions

| Ingredients | Part |
|---|---|
| Sodium chloride | 92 |
| Perfume (see table A) | 3 |
| Spray-dried granule powder 1-5 | 5 |

TABLE 18
Urea-based solid scent booster compositions

| Ingredients | Part |
|---|---|
| Urea (beads) | 86 |
| Spray-dried granule powder 1-5 | 8 |
| Bentonite | 3 |
| Perfume (see table A) | 3 |

1. A laundry composition comprising
a delivery system comprising a biodegradable carrier and a perfume formulation entrapped within the biodegradable carrier,
a free perfume oil, and
laundry additives.

2. A laundry composition according to claim 1, wherein the biodegradable carrier has a biodegradability value of 60% within 60 days according to OECD301F.

3. The laundry composition according to claim 1, wherein the perfume formulation comprises
0 to 60 wt. % of a hydrophobic solvent, based on the total weight of the perfume formulation,
40 to 100 wt. % of a perfume oil, based on the total weight of the perfume formulation, and
optionally, other active ingredients.

4. The laundry composition according to any claim 1, wherein the perfume formulation comprises a perfume oil which has at least two characteristics:
at least 35% perfuming ingredients having a log P above 3,
at least 20% of Bulky materials including one or more of:
perfuming ingredients comprising a cyclohexane, cyclohexene, cyclohexanone, or cyclohexenone ring substituted with at least one 1 to 4 nodes comprising substituent,
perfuming ingredients comprising a cyclopentane, cyclopentene, cyclopentanone, or cyclopentenone ring substituted with at least one 4 or more nodes comprising substituent,
perfuming ingredients comprising a phenyl ring or perfuming ingredients comprising a cyclohexane, cyclohexene, cyclohexanone, or cyclohexenone ring substituted with at least one 5 or more nodes comprising substituent,
perfuming ingredients comprising at least two fused or linked 5 membered or 6 membered rings,
perfuming ingredients comprising a camphor-like ring structure, and
perfuming ingredients comprising at least one 7 to 20 membered ring, and
at least 15% of high impact perfume materials having a Log T<−4.

5. The delivery system according to claim 4, wherein the perfume oil has all of the characteristics.

6. The delivery system according to claim 3, wherein the perfume oil and the hydrophobic solvent have at least two Hansen solubility parameters selected from a first group consisting of: an atomic dispersion force (δd) from 12 to 20, a dipole moment (δp) from 1 to 8, and a hydrogen bonding (δh) from 2.5 to 11.

7. The delivery system according to claim 6, wherein the perfume oil and the hydrophobic solvent have at least two Hansen solubility parameters selected from a second group consisting of: an atomic dispersion force (δd) from 14 to 20, a dipole moment (δp) from 1 to 7, and a hydrogen bonding (δh) from 4 to 11.

8. The laundry composition according to claim 1, wherein the biodegradable carrier is a biodegradable shell or a biodegradable polymeric carrier matrix.

9. The laundry composition according to claim 1, wherein the total amount of the delivery system is 0.05 to 5 wt. %, based on the total weight of the perfuming composition, and the total amount of the free perfume oil is 0.05 to 5 wt. % based on the total weight of the perfuming composition.

10. The laundry composition according to claim 1, wherein the total perfume oil of the perfume formulation entrapped in the delivery system and total free perfume oil are present in the perfuming composition in a weight ratio of 1:20 to 20:1.

11. The laundry composition according to claim 1, wherein the laundry additives comprise dialkyl quaternary ammonium salts, dialkyl ester quaternary ammonium salts (esterquats), Hamburg esterquat (HEQ), TEAQ (triethanolamine quat), silicones, alkylbenzenesulfonate (ABS), secondary alkyl sulfonate (SAS), primary alcohol sulfate (PAS), lauryl ether sulfate (LES), methyl ester sulfonate (MES) and nonionic surfactant such as alkyl amines, alkanolamide, fatty alcohol poly(ethylene glycol) ether, fatty alcohol ethoxylate (FAE), ethylene oxide (EO) and propylene oxide (PO) copolymers, amine oxydes, alkyl polyglucosides, alkyl polyglucosamides, and mixtures thereof.

12. The laundry composition according to claim 1 in the form of a fabric softener, liquid detergent, solid detergent, solid scent booster, liquid scent booster, unidose liquid detergent, tablet powder detergent, dryer sheets, or bleach booster.

13. The laundry composition according to claim 2, wherein the biodegradable carrier has a biodegradability value of 80% within 60 days.

14. The laundry composition according to claim 8, wherein the biodegradable carrier is a biodegradable shell.
